(19) United States
(12) Patent Application Publication
(10) Pub. No.: US 2025/0224186 A1
(43) Pub. Date: Jul. 10, 2025

(54) HEAT EXCHANGER AND AIR CONDITIONER INCLUDING THE SAME

(71) Applicant: Samsung Electronics Co., Ltd., Suwon-si (KR)

(72) Inventors: Minhwan KIM, Suwon-si (KR); Yongki BAEK, Suwon-si (KR); Kangtae SEO, Suwon-si (KR); Yonghwa CHOI, Suwon-si (KR)

(21) Appl. No.: 18/965,780

(22) Filed: Dec. 2, 2024

Related U.S. Application Data
(63) Continuation of application No. PCT/KR2024/096515, filed on Nov. 13, 2024.

(30) Foreign Application Priority Data
Jan. 5, 2024 (KR) 10-2024-0002528

(51) Int. Cl. F28F 9/02; B23K 1/00; B23K 101/14

(52) U.S. Cl. CPC F28F 9/0246; B23K 1/0012; B23K 2101/14; F28F 2275/04

(57) ABSTRACT

A heat exchanger may include: a header including a first header and a second header, an outlet chamber accommodating a refrigerant, and a heat-exchange tube connected to the first header; an outlet pipe inserted in a hole penetrating the second header and in communication with the outlet chamber, and coupled to the second header by brazing and communicating with the outlet chamber and discharging a refrigerant from the outlet chamber to the outside. The outlet pipe may include a first outlet pipe in the outlet chamber and a second outlet pipe extending from the first outlet pipe to the outside, and the first outlet pipe includes a catching protrusion protruding from an outer surface of the first outlet pipe in a radial direction of the first outlet pipe and configured to resist movement of the first outlet pipe departing from the outlet chamber.

### CROSS-REFERENCE TO RELATED APPLICATIONS

This application is a continuation of International Application No. PCT/KR2024/096515 designating the United States, filed on Nov. 13, 2024, in the Korean Intellectual Property Receiving Office and claiming priority to Korean Patent Application No. 10-2024-0002528, filed on Jan. 5, 2024, in the Korean Intellectual Property Office, the disclosures of each of which are incorporated by reference herein in their entireties.

### BACKGROUND

### Field

The disclosure relates to a heat exchanger capable of increasing space utilization and an air conditioner including the heat exchanger.

### Description of Related Art

In general, a heat exchanger is an apparatus for heat-exchanging refrigerants with outside air by including a tube in which the refrigerants flow to exchange heat with outside air, a heat-exchange fin which is in contact with the tube to widen a heat-dissipation area, and a header which communicates with both ends of the tube.

The heat exchanger includes an evaporator and a condenser and configures a refrigeration cycle apparatus together with a compressor for compressing refrigerants and an expansion valve for expanding refrigerants.

The heat exchanger includes an inlet pipe through which outside refrigerants flow into the heat exchanger, and an outlet pipe through which refrigerants are discharged to the outside. The inlet pipe and the outlet pipe communicate with the header to supply refrigerants to the tube or receive refrigerants from the tube.

### SUMMARY

Embodiments of the disclosure provide a heat exchanger with improved space utilization and an air conditioner including the heat exchanger.

Embodiments of the disclosure provide a heat exchanger including a structure for more effectively connecting a pipe through which refrigerants flow to a header, and an air conditioner including the heat exchanger.

A heat exchanger according to example embodiment of the disclosure may include: a header including a first header and a second header detachably coupled to the first header, the header forming an outlet chamber accommodating a refrigerant. The heat exchanger may include a heat-exchange tube connected to the first header, wherein the refrigerant is configured to flow through the heat-exchange tube to exchange heat with outside air. The heat exchanger may include an outlet pipe inserted in a hole penetrating the second header and communicating with the outlet chamber, the outlet pipe being coupled to the second header by brazing and communicating with the outlet chamber and configured to discharge the refrigerant in the outlet chamber. The outlet pipe may include: a first outlet pipe positioned in the outlet chamber and a second outlet pipe extending from the first outlet pipe to the outside. The first outlet pipe may include a catching protrusion protruding from an outer surface of the first outlet pipe in a radial direction of the first outlet pipe and configured to stop the first outlet pipe from departing from the outlet chamber.

A heat exchanger according to an example embodiment of the disclosure may include: a header forming an inlet chamber configured to accommodate a refrigerant flowed thereto and an outlet chamber configured to accommodate a refrigerant. The heat exchanger may include a heat-exchange tube connected to the header, wherein the refrigerant is configured to flow through the heat-exchange tube to exchange heat with outside air. The heat exchanger may include an inlet pipe in communication with the inlet chamber and configured to supply a refrigerant to the inlet chamber, and an outlet pipe coupled to the header by brazing and inserted in a hole penetrating the header and communicating with the outlet chamber and configured to discharge the refrigerant in the outlet chamber. The outlet pipe may include a first outlet pipe positioned in the outlet chamber and a second outlet pipe extending from the first outlet pipe to the outside. The first outlet pipe may include a catching protrusion protruding from an outer surface of the first outlet pipe in a radial direction of the first outlet pipe and configured to stop the first outlet pipe from departing from the outlet chamber.

An air conditioner according to an example embodiment of the disclosure may include: a housing including an inlet port configured to receive drawn in air and an outlet port configured to discharge heat-exchanged air. The air conditioner may include a heat exchanger positioned inside the housing and configured to exchange heat with drawn in air. The air conditioner may include a fan configured to operate to discharge heat-exchanged air to the outside. The heat exchanger may include a first header and a second header detachably coupled to each other. The heat exchanger may include a header forming an outlet chamber configured to accommodate a refrigerant. The heat exchanger may include a heat-exchange tube connected to the first header, wherein a refrigerant is configured to flow through the heat-exchange tube to exchange heat with outside air. The heat exchanger may include an outlet pipe inserted in a hole penetrating the second header and communicating with the outlet chamber, coupled to the second header by brazing, and communicating with the outlet chamber and configured to discharge the refrigerant in the outlet chamber. The outlet pipe may include a first outlet pipe positioned in the outlet chamber and a second outlet pipe extending from the first outlet pipe to the outside. The first outlet pipe may include a catching protrusion protruding from an outer surface of the first outlet pipe in a radial direction of the first outlet pipe and configured to stop the first outlet pipe from departing from the outlet chamber.

### BRIEF DESCRIPTION OF THE DRAWINGS

FIG. 1 is a perspective view illustrating an example air conditioner according to various embodiments;

FIG. 2 is a perspective view illustrating a heat exchanger according to various embodiments;

FIG. 3 is a perspective view illustrating a plurality of heat-exchange tubes and an upper header in a heat exchanger according to various embodiments;

FIG. 4 is an exploded perspective view of the upper header of FIG. 3 according to various embodiments;

FIG. 5 is a cross-sectional view, taken along line A-A′ of FIG. 3 according to various embodiments;

FIG. 6 is a cross-sectional view, taken along line B-B′ of FIG. 3, viewed from above according to various embodiments;

FIG. 7 is a perspective view illustrating a plurality of heat exchange tubes and a lower header in a heat exchanger according to various embodiments;

FIG. 8 is an exploded perspective view of the lower header of FIG. 7 according to various embodiments;

FIG. 9 is a cross-sectional view, taken along line C-C′ of FIG. 7 viewed from below according to various embodiments;

FIG. 10 is a cross-sectional view, taken along line D-D′ of FIG. 7 according to various embodiments;

FIG. 11 is an enlarged view of an area A of FIG. 10 according to various embodiments;

FIG. 12 is a perspective view illustrating an outlet pipe, a second header, and a cover ring in a heat exchanger according to various embodiments;

FIG. 13 is a partial exploded perspective view showing an outlet pipe, a second header, and a cover ring in a heat exchanger according to various embodiments;

FIG. 14 is a diagram illustrating a side view of FIG. 13 according to various embodiments;

FIG. 15 is a diagram illustrating a top view of FIG. 13 according to various embodiments;

FIG. 16 is a cross-sectional view of FIG. 12 according to various embodiments;

FIG. 17 is a diagram illustrating a state in which a catching member is formed in a first outlet pipe in FIG. 16 according to various embodiments;

FIG. 18 is a cross-sectional view of FIG. 12 according to various embodiments;

FIG. 19 is a diagram illustrating a state in which a pair of flat portions are processed to be inclined in FIG. 18 according to various embodiments;

FIG. 20 is a perspective view illustrating an outlet pipe, an inlet pipe, a second header, and a cover ring in a heat exchanger according to various embodiments;

FIG. 21 is an exploded perspective view of FIG. 20 according to various embodiments;

FIG. 22 is a partial exploded perspective view of FIG. 20 viewed from another angle according to various embodiments;

FIG. 23 is a cross-sectional view taken along line E-E′ of FIG. 22 after components of FIG. 22 are combined according to various embodiments.

### DETAILED DESCRIPTION

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

An air conditioner according to various embodiments may refer to a device that performs functions such as purification, ventilation, humidity control, cooling or heating in an air conditioning space (hereinafter referred to as “indoor space”), and in particular a device having at least one of these functions.

According to an embodiment, an air conditioner may include a heat pump device to perform a cooling function or a heating function. The heat pump device may include a refrigeration cycle in which a refrigerant is circulated through a compressor, a first heat exchanger, and an expansion device and a second heat exchanger. Components of the heat pump device may be embedded in a single housing forming an exterior of an air conditioner, which includes a window-type air conditioner or a portable air conditioner. On the other hand, some components of the heat pump device may be divided and embedded in a plurality of housings forming a single air conditioner, which includes a wall-mounted air conditioner, a stand-type air conditioner, and a system air conditioner.

The air conditioner including the plurality of housings may include at least one outdoor unit installed outdoors and at least one indoor unit installed indoors. For example, the air conditioner may be provided such that a single outdoor unit and a single indoor unit are connected by a refrigerant pipe. Alternatively, the air conditioner may be provided such that a single outdoor unit is connected to two or more indoor units by a refrigerant pipe. Alternatively, the air conditioner may be provided such that two or more outdoor units and two or more indoor units are connected by a plurality of refrigerant pipes.

The outdoor unit may be electrically connected to the indoor unit. For example, information (or commands) for controlling the air conditioner may be received through an input interface provided in the outdoor unit or the indoor unit. The outdoor unit and the indoor unit may operate simultaneously or sequentially in response to a user input.

The air conditioner may include an outdoor heat exchanger provided in the outdoor unit, an indoor heat exchanger provided in the indoor unit, and a refrigerant pipe connecting the outdoor heat exchanger and the indoor heat exchanger.

The outdoor heat exchanger may be configured to exchange heat between a refrigerant and air from outdoor through a phase change of the refrigerant (e.g., evaporation or condensation). For example, while the refrigerant is condensed in the outdoor heat exchanger, the refrigerant may radiate heat to the outdoor air. While the refrigerant flowing in the outdoor heat exchanger evaporates, the refrigerant may absorb heat from the outdoor air.

The indoor unit is installed indoors. For example, according to the arrangement method of the indoor unit, the air conditioner may be classified into a ceiling-type indoor unit, a stand-type indoor unit, a wall-type indoor unit, and the like. For example, the ceiling-type indoor unit may be classified into a 4-way type indoor unit, a 1-way type indoor unit, a duct type indoor unit and the like according to a method of discharging air.

Similarly, the indoor heat exchanger may be configured to exchange heat between a refrigerant and outdoor air through a phase change of the refrigerant (e.g., evaporation or condensation). For example, while the refrigerant evaporates in the indoor unit, the refrigerant may absorb heat from the indoor air. The indoor space may be cooled by blowing the indoor air cooled through the cooled indoor heat exchanger. While the refrigerant is condensed in the indoor heat exchanger, the refrigerant may radiate heat to the indoor air. The indoor space may be heated by blowing the indoor air heated through the high-temperature indoor heat exchanger.

In other words, the air conditioner may perform a cooling or heating function by a phase change process of a refrigerant circulated between the outdoor heat exchanger and the indoor heat exchanger. To circulate the refrigerant, the air conditioner may include a compressor to compress the refrigerant. The compressor may draw refrigerant gas through an inlet and compress the refrigerant gas. The compressor may discharge high-temperature and high-pressure refrigerant gas through an outlet. The compressor may be disposed inside the outdoor unit.

Through the refrigerant pipe, the refrigerant may be circulated sequentially through the compressor, the outdoor heat exchanger, the expansion device, and the indoor heat exchanger or sequentially circulated through the compressor, the indoor heat exchanger, the expansion device, and the outdoor heat exchanger.

For example, in the air conditioner, when a single outdoor unit and a single indoor unit are directly connected through a refrigerant pipe, the refrigerant may be circulated between the single outdoor unit and the single indoor unit through the refrigerant pipe.

For example, in the air conditioner, when a single outdoor unit is connected to two or more indoor units through a refrigerant pipe, the refrigerant may flow from the single outdoor unit to the plurality of indoor units through branched refrigerant pipes. Refrigerant discharged from the plurality of indoor units may be combined and circulated to the outdoor unit. For example, each of the plurality of indoor units may be directly connected in parallel to the single outdoor unit through a separate refrigerant pipe.

Each of the plurality of indoor units may be operated independently according to an operation mode set by a user. In other words, some of the plurality of indoor units may be operated in a cooling mode while others of the plurality of indoor units are operated in a heating mode. At that time, the refrigerant may be selectively introduced into each indoor unit in a high-pressure state or a low-pressure state, discharged, and circulated to the outdoor unit along a circulation path that is designated through a flow path switching valve to be described in greater detail below.

For example, in the air conditioner, when two or more outdoor units and two or more indoor units are connected by the plurality of refrigerant pipes, refrigerant discharged from the plurality of outdoor units may be combined and flow through one refrigerant pipe, and then diverged again at a certain point and introduced into the plurality of indoor units.

The plurality of outdoor units may be driven or at least some of the plurality of outdoor units may not be driven, in accordance with to a driving load corresponding to an operating amount of the plurality of indoor units. At that time, the refrigerant may be provided through a flow path switching valve to be introduced into and circulated to an outdoor unit that is selectively driven. The air conditioner may include the expansion device to reduce the pressure of the refrigerant flowing into the heat exchanger. For example, the expansion device may be disposed inside the indoor unit or inside the outdoor unit, or disposed both inside the indoor unit and the outdoor unit.

The expansion device may reduce the temperature and pressure of the refrigerant using a throttling effect. The expansion device may include an orifice configured to reduce a cross-sectional area of a flow path. A temperature and pressure of the refrigerant passing through the orifice may be lowered.

For example, the expansion device may be implemented as an electronic expansion valve configured to adjust an opening ratio (a ratio of a cross-sectional area of a flow path of a valve in a partially opened state to a cross-sectional area of the flow path of the valve in a fully opened state). According to the opening ratio of the electronic expansion valve, the amount of refrigerant passing through the expansion device may be adjusted.

The air conditioner may further include a flow path switching valve disposed on the refrigerant circulation path. The flow path switching valve may include a 4-way valve. The flow path switching valve may determine a refrigerant circulation path depending on an operation mode of the indoor unit (e.g., cooling operation or heating operation). The flow path switching valve may be connected to the outlet of the compressor.

The air conditioner may include an accumulator. The accumulator may be connected to the inlet of the compressor. A low-temperature and low-pressure refrigerant, which is evaporated in the indoor heat exchanger or the outdoor heat exchanger, may flow into the accumulator.

When a refrigerant mixture of refrigerant liquid and refrigerant gas is introduced, the accumulator may separate the refrigerant liquid from the refrigerant gas, and supply the refrigerant gas separated from the refrigerant liquid to the compressor.

An outdoor fan may be installed near the outdoor heat exchanger. The outdoor fan may blow outdoor air to the outdoor heat exchanger to promote heat exchange between the refrigerant and the outdoor air.

The outdoor unit of the air conditioner may include at least one sensor. For example, the outdoor unit sensor may be provided as an environmental sensor. The outdoor unit sensor may be disposed at a given position of the inside or the outside of the outdoor unit. For example, the outdoor unit sensor may include a temperature sensor configured to detect an air temperature around the outdoor unit, an air humidity sensor configured to detect air humidity around the outdoor unit, or a refrigerant temperature sensor configured to detect a refrigerant temperature in a refrigerant pipe passing through the outdoor unit, or a refrigerant pressure sensor configured to detect a refrigerant pressure in a refrigerant pipe passing through the outdoor unit.

The outdoor unit of the air conditioner may include an outdoor unit communication circuitry. The outdoor unit communication circuitry may be configured to receive a control signal from an indoor unit controller of the air conditioner, which will be described in greater detail below. Based on a control signal received through the outdoor unit communication circuitry, the outdoor unit may control the operation of the compressor, the outdoor heat exchanger, the expansion device, the flow path switching valve, the accumulator, or the outdoor fan. The outdoor unit may transmit a measurement value detected by the outdoor unit sensor to the indoor unit controller through the outdoor unit communication circuitry.

The indoor unit of the air conditioner may include a housing, a blower configured to circulate air inside or outside the housing, and the indoor heat exchanger configured to exchange heat with air introduced into the housing.

The housing may include an inlet. Indoor air may flow into the housing through the inlet.

The indoor unit of the air conditioner may include a filter configured to filter out foreign substance in air that is introduced into the inside of the housing through the inlet.

The housing may include an outlet. Air flowing inside the housing may be discharged to the outside of the housing through the outlet.

An airflow guide configured to guide a direction of air discharged through the outlet may be provided in the housing of the indoor unit. For example, the airflow guide may include a blade positioned in the outlet. For example, the airflow guide may include an auxiliary fan for regulating an exhaust airflow, but is not limited thereto. Alternatively, the airflow guide may be omitted.

The indoor heat exchanger and the blower arranged on a flow path connecting the inlet and the outlet may be disposed inside the housing of the indoor unit.

The blower may include an indoor fan and a fan motor. For example, the indoor fan may include an axial fan, a mixed-flow fan, a cross-flow fan and a centrifugal fan.

The indoor heat exchanger may be arranged between the blower and the outlet or between the inlet and the blower. The indoor heat exchanger may absorb heat from air introduced through the inlet or transfer heat to air introduced through the inlet. The indoor heat exchanger may include a heat exchange tube through which refrigerant flows, and heat exchange fins in contact with the heat exchange tube to increase a heat transfer area.

The indoor unit of the air conditioner may include a drain tray disposed below the indoor heat exchanger to collect condensed water generated in the indoor heat exchanger. The condensed water contained in the drain tray may be drained to the outside through a drain hose. The drain tray may be arranged to support the indoor heat exchanger.

The indoor unit of the air conditioner may include an input interface. The input interface may include any type of user input means including a button, a switch, a touch screen and/or a touch pad. A user can directly input setting data (e.g., desired indoor temperature, cooling/heating/dehumidifying/air cleaning operation mode setting, outlet selection setting, and/or air volume setting) through the input interface.

The input interface may be connected to an external input device. For example, the input interface may be electrically connected to a wired remote controller. The wired remote controller may be installed at a specific location (e.g., a part of a wall) in an indoor space. A user may input setting data related to the operation of the air conditioner by manipulating the wired remote controller. An electrical signal corresponding to the setting data obtained by the wired remote controller may be transmitted to the input interface. In addition, the input interface may include an infrared sensor. A user may remotely input the setting data for operating the air conditioner using a wireless remote controller. The setting data received by the wireless remote controller may be transmitted to the input interface as an infrared signal.

In addition, the input interface may include a microphone. A user's voice command may be obtained through the microphone. The microphone may convert a user's voice command into an electrical signal and transmit the converted electrical signal to the indoor unit controller. The indoor unit controller may control components of the air conditioner to perform a function corresponding to the user's voice command. The setting data obtained through the input interface (e.g., desired indoor temperature, cooling/heating/dehumidifying/air cleaning operation mode setting, outlet selection setting, and/or air volume setting) may be transmitted to the indoor unit controller to be described in greater detail below. For example, the setting data obtained through the input interface may be transmitted to the outside, that is, to the outdoor unit or a server through an indoor unit communication circuitry to be described in greater detail below.

The indoor unit of the air conditioner may include a power module. The power module may be connected to an external power source to supply power to components of the indoor unit.

The indoor unit of the air conditioner may include an indoor unit sensor. The indoor unit sensor may be an environmental sensor disposed inside or outside the housing. For example, the indoor unit sensor may include one or more temperature sensors and/or humidity sensors disposed in a predetermined space inside or outside the housing of the indoor unit. For example, the indoor unit sensor may include a refrigerant temperature sensor configured to detect a refrigerant temperature of a refrigerant pipe passing through the indoor unit. For example, the indoor unit sensor may include a refrigerant temperature sensor each configured to detect a temperature of an entrance, a middle portion and/or an exit of the refrigerant pipe passing through the indoor heat exchanger.

For example, each environmental information detected by the indoor unit sensor may be transmitted to the indoor unit controller to be described in greater detail below or transmitted to the outside through the indoor unit communication circuitry to be described in greater detail below.

The indoor unit of the air conditioner may include the indoor unit communication circuitry. The indoor unit communication circuitry may include at least one of a short-range wireless communication module and a long-range wireless communication module. The indoor unit communication circuitry may include at least one antenna for wirelessly communicating with other devices. The outdoor unit may include the outdoor unit communication circuitry. The outdoor unit communication circuitry may also include at least one of a short-range wireless communication module and a long-range wireless communication module.

The short-range wireless communication module may include a Bluetooth communication module, a Bluetooth Low Energy (BLE) communication module, a near field communication module, a WLAN (Wi-Fi) communication module, and a Zigbee communication module, an infrared data association (IrDA) communication module, a Wi-Fi Direct (WFD) communication module, an ultrawideband (UWB) communication module, an Ant+ communication module, a microwave (uWave) communication module, etc., but is not limited thereto.

The long-range wireless communication module may include a communication module that performs various types of long-range wireless communication, and may include a mobile communication circuitry. The mobile communication circuitry transmits and receives radio signals with at least one of a base station, an external terminal, and a server in a mobile communication network.

The indoor unit communication circuitry may communicate with an external device such as a server, a mobile device and other home appliances through an access point (AP). The AP may connect a local area network (LAN), to which an air conditioner or a user device is connected, to a wide area network (WAN) to which a server is connected. The air conditioner or the user device may be connected to the server through the WAN. The indoor unit of the air conditioner may include the indoor unit controller configured to control components of the indoor unit including the blower. The outdoor unit of the air conditioner may include an outdoor unit controller configured to control components of the outdoor unit including the compressor. The indoor unit controller may communicate with the outdoor unit controller through the indoor unit communication circuitry and the outdoor unit communication circuitry. The outdoor unit communication circuitry may transmit a control signal generated by the outdoor unit controller to the indoor unit communication circuitry, or transmit a control signal, which is transmitted from the indoor unit communication circuitry, to the outdoor unit controller. In other words, the outdoor unit and the indoor unit may perform bi-directional communication. The outdoor unit and the indoor unit may transmit and receive various signals generated during the operation of the air conditioner.

The outdoor unit controller may be electrically connected to components of the outdoor unit and may control the operation of each component. For example, the outdoor unit controller may adjust a frequency of the compressor and control the flow path switching valve to change a circulation direction of the refrigerant. The outdoor unit controller may adjust a rotational speed of the outdoor fan. In addition, the outdoor unit controller may generate a control signal to adjust the opening degree of the expansion valve. Under the control of the outdoor unit controller, the refrigerant may be circulated along the refrigerant circulation circuit including the compressor, the flow path switching valve, the outdoor heat exchanger, the expansion valve, and the indoor heat exchanger.

Various temperature sensors included in the outdoor unit and the indoor unit may transmit electrical signals corresponding to detected temperatures to the outdoor unit controller and/or the indoor unit controller. For example, the humidity sensors included in the outdoor unit and the indoor unit may respectively transmit electrical signals corresponding to the detected humidity to the outdoor unit controller and/or the indoor unit controller.

The indoor unit controller may obtain a user input from a user device including a mobile device through the indoor unit communication circuitry, or directly obtain a user input through the input interface or the remote controller. The indoor unit controller may control components of the indoor unit including the blower in response to the received user input. The indoor unit controller may transmit information related to the received user input to the outdoor unit controller of the outdoor unit.

The outdoor unit controller may control components of the outdoor unit including the compressor based on the information related to the user input received from the indoor unit. For example, when a control signal corresponding to a user input for selecting an operation mode such as a cooling operation, a heating operation, a fan operation, a defrosting operation, or a dehumidifying operation is received from the indoor unit, the outdoor unit controller may control components of the outdoor unit to perform an operation of the air conditioner corresponding to the selected operation mode.

The outdoor unit controller and the indoor unit controller may include a processor and a memory, respectively. The indoor unit controller may include at least one a first processor and at least one a first memory, and the outdoor unit controller may include at least one a second processor and at least one a second memory.

The memory may record/store various types of information necessary for the operation of the air conditioner. The memory may store instructions, applications, data and/or programs necessary for the operation of the air conditioner. For example, the memory may store various programs for the cooling operation, the heating operation, the dehumidifying operation, and/or the defrosting operation of the air conditioner. The memory may include volatile memory, such as a static random access memory (S-RAM) and a dynamic random access memory (D-RAM) for temporarily storing data. In addition, the memory may include a non-volatile memory, such as a read only memory (ROM), an erasable programmable read only memory (EPROM), and an electrically erasable programmable read only memory (EEPROM) for long-term storage of data.

The processor may include various processing circuitry and generate a control signal for controlling an operation of the air conditioner based on instructions, applications, data, and/or programs stored in the memory. The processor may be hardware and may include a logic circuit and an arithmetic circuit. The processor may process data according to a program and/or instructions provided from the memory, and may generate a control signal according to a processing result. The memory and the processor may be implemented as one control circuit or as a plurality of circuits.

The indoor unit of the air conditioner may include an output interface. The output interface may be electrically connected to the indoor unit controller, and output information related to the operation of the air conditioner under the control of the indoor unit controller. For example, the output interface may output information, such as an operation mode selected by a user input, a wind direction, a wind volume, and a temperature. In addition, the output interface may output sensing information obtained from the indoor unit sensor or the outdoor unit sensor, and output warning/error messages.

The output interface may include a display and a speaker. The speaker may be a sound device and configured to output various sounds. The display may display information, which is input by a user or provided to a user, as various graphic elements. For example, operational information of the air conditioner may be displayed as at least one of an image and text. In addition, the display may include an indicator that provides specific information. The display may include a liquid crystal display (LCD) panel, a light emitting diode (LED) panel, an organic light emitting diode (OLED) panel, a micro-LED panel, and/or a plurality of LEDs.

Hereinafter, a heat exchanger and an air conditioner including the same according to various embodiments of the disclosure will be described in greater detail with reference to the accompanying drawings.

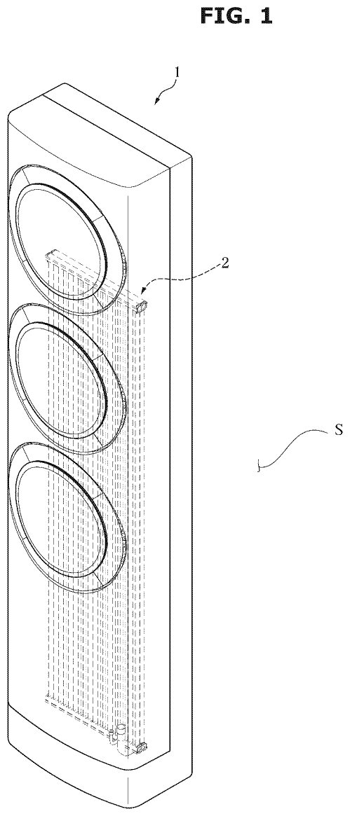

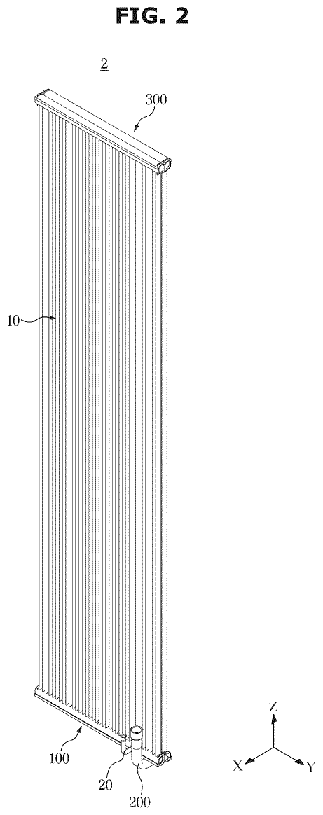

FIG. 1 is a perspective view illustrating an example air conditioner according to various embodiments. FIG. 2 is a perspective view illustrating a heat exchanger according to various embodiments.

Referring to FIGS. 1 and 2, an air conditioner 1 may intake air of outside S through an inlet port. The air conditioner 1 may include a heat exchanger 2 that heat-exchanges intake outside air.

The air conditioner 1 may include a housing. The heat exchanger 2 may be positioned inside the housing.

The air conditioner 1 may discharge air to the outside S through an outlet port. The air conditioner 1 may include a fan that operates to discharge air to the outside S. The air conditioner 1 may discharge heat-exchanged air to the outside S.

The heat exchanger 2 may exchange heat with air. The heat exchanger 2 may include a heat-exchange tube 10 through which a refrigerant for exchanging heat with air received from the outside S flows, and an upper header 300 and a lower header 100 that communicate with the heat-exchange tube 10. The heat-exchange tube 10 may be provided as a plurality of heat-exchange tubes 10.

The heat exchanger 2 may include an inlet pipe 20 connected to the lower header 100. For example, while the air conditioner 1 operates a heating cycle, a refrigerant may flow into an expansion device outside the heat exchanger 2 through the inlet pipe 20. For example, while the air conditioner 1 operates a cooling cycle, a refrigerant may flow into the lower header 100 through the inlet pipe 20.

The heat exchanger 2 may include an outlet pipe 200 connected to the lower header 100. For example, while the air conditioner 1 operates a heating cycle, a refrigerant may flow into the lower header 100 through the outlet pipe 200. For example, while the air conditioner 1 operates a cooling cycle, a refrigerant inside the lower header 100 may be discharged to a compressor through the outlet pipe 200.

For example, while the air conditioner 1 operates a heating cycle, a high-temperature and high-pressure refrigerant may flow into the lower header 100 through the outlet pipe 200.

The refrigerant may pass through the heat-exchange tube 10 to exchange heat with air of the outside S and change to a low-temperature refrigerant. The low-temperature refrigerant may be condensed and the condensed refrigerant may be discharged to the expansion device from the header through the inlet pipe 20. That is, during the heating cycle, the heat exchanger 2 may function as a condenser.

For example, while the air conditioner 1 operates a cooling cycle, a low-temperature, low-pressure liquid or gaseous refrigerant that has passed through the expansion valve may flow into the lower header 100 through the inlet pipe 20. The refrigerant flowed into the inlet pipe 20 may pass through the heat-exchange tube 10 to exchange heat with air of the outside S and change to a high-temperature refrigerant. The high-temperature refrigerant may be expanded and the expanded refrigerant may be discharged to the compressor from the header through the outlet pipe 200. That is, during the cooling cycle, the heat exchanger 2 may function as an evaporator.

The following descriptions will be, for convenience of description, provided under an assumption that a heat exchanger according to an embodiment of the disclosure functions as an evaporator. However, the heat exchanger may also function as a condenser, as described above.

For example, the heat-exchange tube 10 may have a plurality of micro channels formed therein, wherein a refrigerant flows through the micro channels. For example, the heat-exchange tube 10 may have a substantially hollow cylindrical shape. For example, a cross-section of the heat-exchange tube 10 may have a substantially oval shape.

For example, the heat-exchange tube 10 may be arranged in two rows of a front row and a rear row. For example, the front row positioned in a front direction (+X direction) may be defined as a first row and the rear row positioned in a rear direction (−X direction) may be defined as a second row. For example, the heat-exchange tube 10 may extend in a vertical direction (+Z and −Z directions). For example, the heat-exchange tube 10 may be extrusion-molded from an aluminum material.

A heat-exchange fin may be positioned between the heat-exchange tubes 10 in such a way as to be in contact with the heat-exchange tubes 10 to increase an area of heat transfer with air of the outside S, although not shown in the drawings.

The heat-exchange fin may be provided in various known types such as a corrugated fin, and may have a louver for improving heat transfer and drainage performance. The heat-exchange fin may be formed of an aluminum material and coupled to the heat-exchange tubes 10 through, for example, a brazing process.

For example, the brazing process may include a method of bonding base metals with melting points above a specific temperature by positioning a filler metal with a lower melting point at bonding parts of the base metals and heating to the corresponding temperature to melt the filter metal. In the current embodiment, the header and the outlet pipe may be bonded with each other through the brazing process using the header and the outlet pipe as base metals and a solder ring as a filler metal, which will be described in greater detail below.

The above-described structure and shape of the heat-exchange tube 10 are simply examples, and the heat-exchange tube 10 may be provided in various structures and shapes through which a refrigerant flows.

The upper header 300 and the lower header 100 may be spaced a preset distance from each other. For example, the upper header 300 may be located at an upper position (+Z direction) than the lower header 100.

The plurality of heat-exchange tubes 10 may be arranged in a space formed between the upper header 300 and the lower header 100 spaced from each other.

One ends in upper direction (+Z direction) of the plurality of heat-exchange tubes 10 may be connected to the upper header 300. An internal space of each of the plurality of heat-exchange tubes 10 may communicate with an inside of the upper header 300. Accordingly, a refrigerant flowing through each of the plurality of heat-exchange tubes 10 may flow into the inside of the upper header 300.

One ends in lower direction (−Z direction) of the plurality of heat-exchange tubes 10 may be connected to the lower header 100. An internal space of each of the plurality of heat-exchange tubes 10 may communicate with an inside of the lower header 100. Accordingly, a refrigerant flowing through each of the plurality of heat-exchange tubes 10 may flow into the inside of the lower header 100.

The refrigerant may be supplied from the expansion device (not shown) to the inlet pipe 20. The refrigerant supplied to the inlet pipe 20 may flow into the lower header 100 connected to the inlet pipe 20. The refrigerant supplied to the lower header 100 may flow into the upper header 300 through the plurality of heat-exchange tubes 10. Thereafter, the refrigerant may exchange heat with air, flow into the lower header 100, and then be discharged to the compressor (not shown) through the outlet pipe 200.

For example, the lower header 100 may be integrally coupled with the inlet pipe 20 and the outlet pipe 200 by a brazing process. For example, for the brazing process, at least one of the lower header 100, the inlet pipe 20, or the outlet pipe 200 may include a clad material.

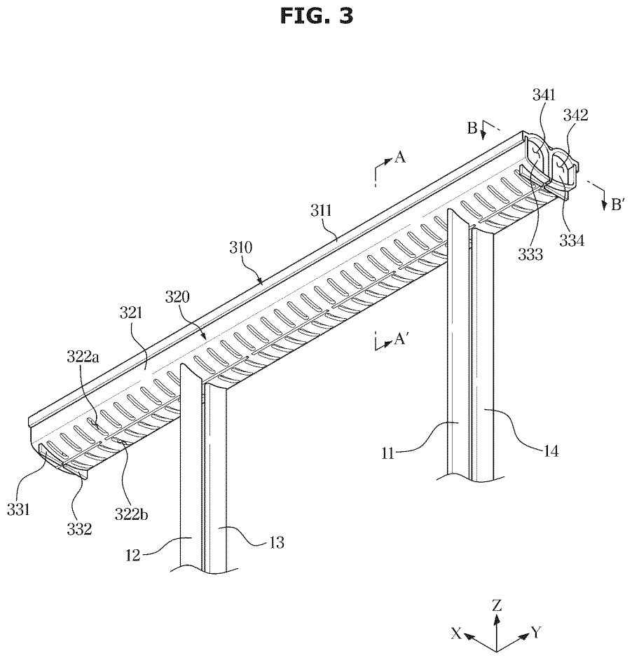

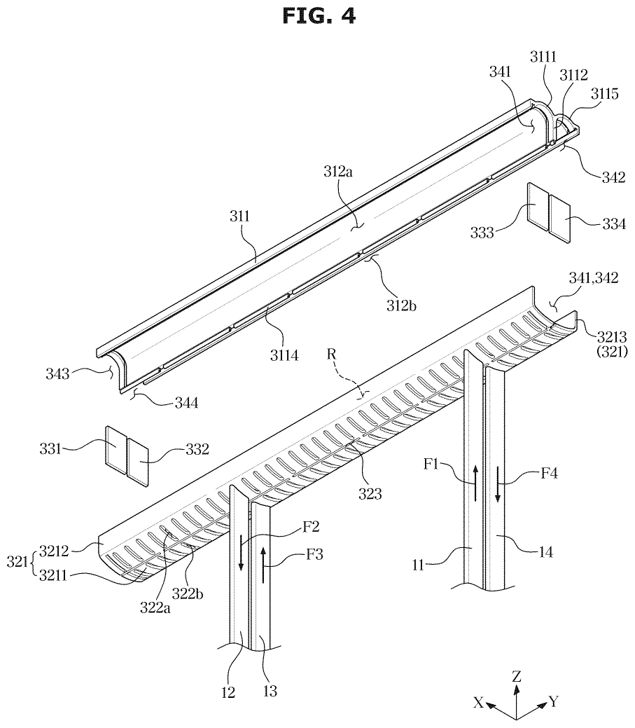

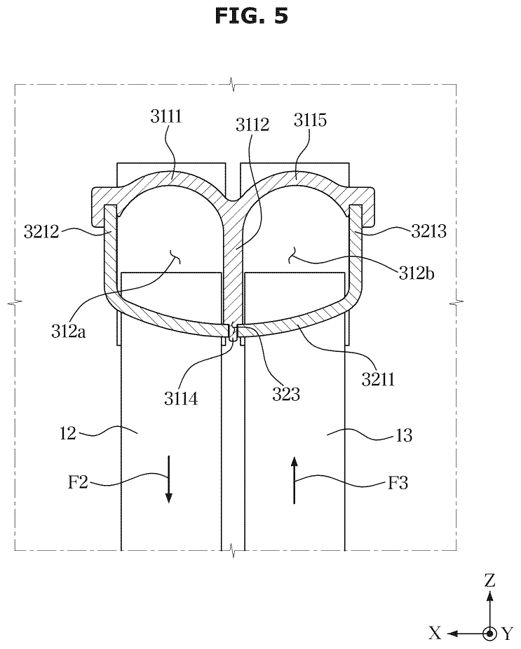

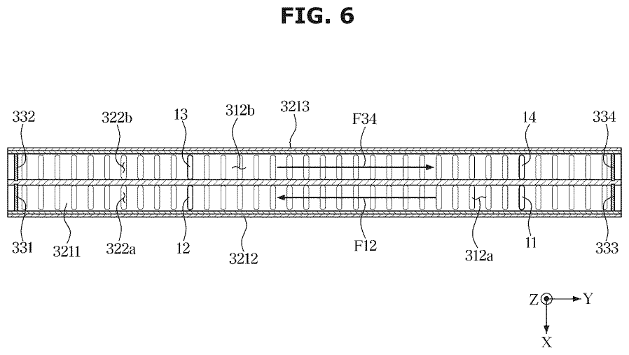

FIG. 3 is a perspective view illustrating examples of a plurality of heat-exchange tubes and an upper header in a heat exchanger according to various embodiments. FIG. 4 is an exploded perspective view of the upper header of FIG. 3 according to various embodiments. FIG. 5 is a cross-sectional view, taken along line A-A′ of FIG. 3 according to various embodiments. FIG. 6 is a cross-sectional view of, taken along line B-B′ of FIG. 3, viewed from above (+Z direction) according to various embodiments.

Referring to FIGS. 3, 4, 5 and 6 (which may be referred to as FIGS. 3 to 6), the upper header 300 of the heat exchanger 2 may include an upper body 310 and an upper cover 320 detachably coupled to the upper body 310. Hereinafter, the plurality of heat-exchange tubes 10 that communicate with the upper header 300 will be briefly described as a first tube 11, a second tube 12, a third tube 13, and a fourth tube 14, for convenience of description.

The upper body 310 may include an upper body housing 311 forming an appearance, a first row 3111 forming a front side in +X direction of the upper body 310 as a part of the upper body housing 311, a second row 3115 forming a rear side in −X direction of the upper body 310 as another part of the upper body housing 311, and an upper body partition wall 3112 formed between the first row 3111 of the upper body 310 and the second row 3115 of the upper body 310 as another part of the upper body housing 311, the upper body partition wall 3112 extending downward (−Z direction).

The upper body housing 311 may extend in a left-right direction (+Y and −Y directions). For example, the first row 3111 of the upper body 310 and the second row 3115 of the upper body 310 may be formed to be convex upward (+Z direction). The upper body partition wall 3112 may also extend in the left-right direction.

According to coupling of the upper body 310 and the upper cover 320, the first row 3111 and the upper body partition wall 3112 of the upper body 310 may form a first upper chamber 312a together with the upper cover 320. In other words, the first upper chamber 312a may be defined as a space surrounded by the first row 3111 and the upper body partition wall 3112 of the upper body 310 and the upper cover 320. A part of an upper cover chamber R formed by the upper cover housing 321 may also be defined as the first upper chamber 312a, which will be described in greater detail below.

The upper body 310 may include first row header holes 341 and 343 defined as both ends of the first upper chamber 312a. The first row header holes 341 and 343 may communicate with the outside S. Because the first row header holes 341 and 343 are closed from the outside S by partition baffles, a refrigerant may flow stably in the first upper chamber 312a.

According to coupling of the upper body 310 and the upper cover 320, the second row 3115 and the upper body partition wall 3112 of the upper body 310 may form a second upper chamber 312b together with the upper cover 320. In other words, the second upper chamber 312b may be defined as a space surrounded by the second row 3115 and the upper body partition wall 3112 of the upper body 310 and the upper cover 320. Another part of the upper cover chamber R formed by the upper cover housing 321 may be defined as the second upper chamber 312b, which will be described in greater detail below.

The upper body partition wall 3112 may partition the first upper chamber 312a and the second upper chamber 312b.

The upper body 310 may include second row header holes 342 and 344 defined as both ends of the second upper chamber 312b. The second row header holes 342 and 344 may communicate with the outside S. Because the second row header holes 342 and 344 are closed from the outside S by partition baffles, a refrigerant may flow stably in the second upper chamber 312b.

The upper body 310 may include an upper body coupling rib 3114 formed in the upper body partition wall 3112. The upper body coupling rib 3114 may protrude downward (−Z direction, −Z side) from the upper body partition wall 3112.

The upper body coupling rib 3114 may be formed to extend in a longitudinal direction (+Y and −Y directions) of the upper body partition wall 3112 along the upper body partition wall 3112. By inserting the upper body coupling rib 3114 into an upper cover coupling groove 323 (will be described in greater detail below) of the upper cover 320, the upper body 310 may be coupled to the upper cover 320.

The upper cover 320 may include the upper cover housing 321 forming an appearance, and an upper cover lower portion 3311 forming a lower side as a part of the upper cover housing 321. The upper cover housing 321 may extend in the left-right direction (+Y and −Y directions).

The upper cover 320 may include a first row 3212 which is another part of the upper cover housing 321, faces the front direction (+X direction), and extends upward (+Z direction) from one end of an upper cover lower portion 3211.

The upper cover 320 may include a second row 3213 which is another part of the upper cover housing 321, faces the rear direction (−X direction), and extends upward (+Z direction) from another end of the upper cover lower portion 3211.

An internal space surrounded by the upper cover lower portion 3211, the first row 3212 of the upper cover 320, and the second row 3213 of the upper cover 320 may be defined as the upper cover chamber R. The upper cover chamber R may include, at both ends, the upper cover holes 341, 342, 343, and 344 that communicate with the outside S.

According to coupling of the upper body 310 and the upper cover 320, the upper cover holes 341, 342, 343, and 344 may be defined as the first row header holes 341 and 343 and the second row header holes 342 and 344. In other words, both ends of a part of the upper cover chamber R forming the first row in the front direction (+X direction) may be defined as the first row header holes 341 and 343, and both ends of another part of the upper cover chamber R forming the second row in the rear direction (−X direction) may be defined as the second row header holes 342 and 344.

The upper cover 320 may include an upper tube hole 322 formed in the upper cover lower portion 3211. A plurality of upper tube holes 322 may be provided. According to coupling of the plurality of heat-exchange tubes 10 and the upper header 300, the plurality of upper tube holes 322 may communicate with insides of the plurality of heat-exchange tubes 10.

Some of the plurality of upper tube holes 322 may include first row upper tube holes 322a arranged in the first row 3212 of the upper cover 320 along a longitudinal direction of the upper cover 320. A remaining part of the plurality of upper tube holes 322 may include second row upper tube holes 322b arranged in the second row 3213 of the upper cover 320 along the longitudinal direction of the upper cover 320.

For example, the first tube 11 may be coupled to and communicate with any one of the first row upper tube holes 322a. For example, the second tube 12 may be coupled to and communicate with another one of the first row upper tube holes 322a.

For example, the first tube 11 may supply a refrigerant from the lower header 100 to the first upper chamber 312a of the upper header 300. For example, the second tube 12 may retrieve the refrigerant from the first upper chamber 312a of the upper header 300 to the lower header 100.

For example, a refrigerant supplied to the first upper chamber 312a through the first tube 11 may flow into the second tube 12 from the first upper chamber 312a and then be retrieved to the lower header 100. For example, a refrigerant supplied to the second upper chamber 312b through the third tube 13 may flow into the fourth tube 14 from the second upper chamber 312b and then be retrieved to the lower header 100.

For example, the third tube 13 may be coupled to and communicate with any one of the second row upper tube holes 322b. For example, the fourth tube 14 may be coupled to and communicate with another one of the second row upper tube holes 322b. For example, the third tube 13 may supply a refrigerant from the lower header 100 to the second upper chamber 312b of the upper header 300. For example, the fourth tube 14 may retrieve a refrigerant from the second upper chamber 312b of the upper header 300 to the lower header 100.

The upper cover 320 may include an upper cover coupling groove 323 extending in the upper cover lower portion 3211 along the longitudinal direction of the upper cover 320. For example, the upper cover coupling groove 323 may include a groove formed in an inner part of the upper cover lower portion 3211. By inserting the upper body coupling rib 3114 of the upper body 310 into the upper cover coupling groove 323 of the upper cover 320, the upper body 310 may be coupled to the upper cover 320.

The upper header 300 may include a partition baffle 331, 332, 333, and 334 positioned in the upper portion. The partition baffle 331, 332, 333, and 334 may include a plurality of partition baffles 331, 332, 333, and 334. According to coupling of the upper body 310 and the upper cover 320, the partition baffles 331, 332, 333, and 334 may be positioned between the upper body 310 and the upper cover 320. According to coupling of the upper body 310 and the upper cover 320, the partition baffles 331, 332, 333, and 334 may be coupled to the upper body 310 and the upper cover 320.

Some partition baffles 331 and 333 of the plurality of partition baffles 331, 332, 333, and 334 may be positioned at both ends of the first upper chamber 312a to close the first row header holes 341 and 343. Because the partition baffles 331 and 333 of the plurality of partition baffles 331, 332, 333, and 334 close the first row header holes 341 and 343, the first upper chamber 312a may be isolated from the outside S. Accordingly, a refrigerant may flow stably inside the first upper chamber 312a.

The other partition baffles 332 and 334 of the plurality of partition baffles 331, 332, 333, and 334 may be positioned at both ends of the second upper chamber 312b to close the second row header holes 342 and 344. Because the other partition baffles 332 and 334 of the plurality of partition baffles 331, 332, 333, and 334 close the second row header holes 342 and 344, the second upper chamber 312b may be isolated from the outside S. Accordingly, a refrigerant may flow stably inside the second upper chamber 312b.

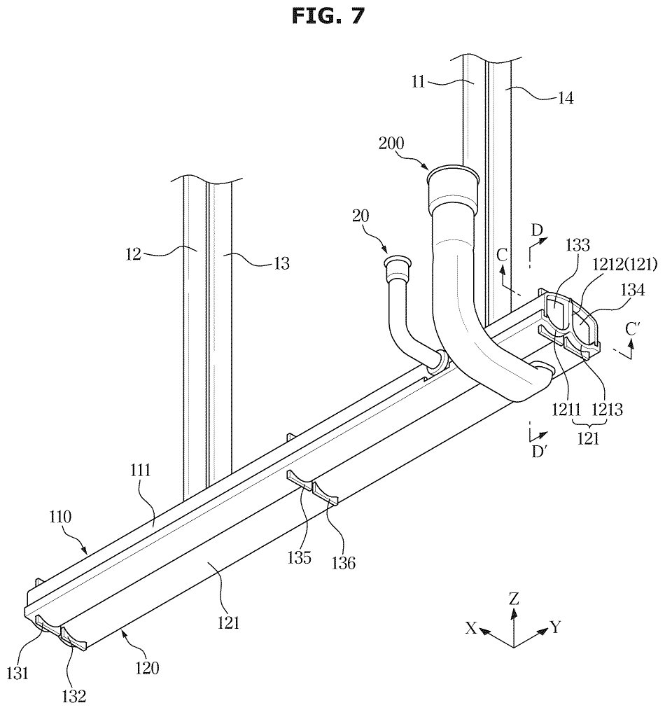

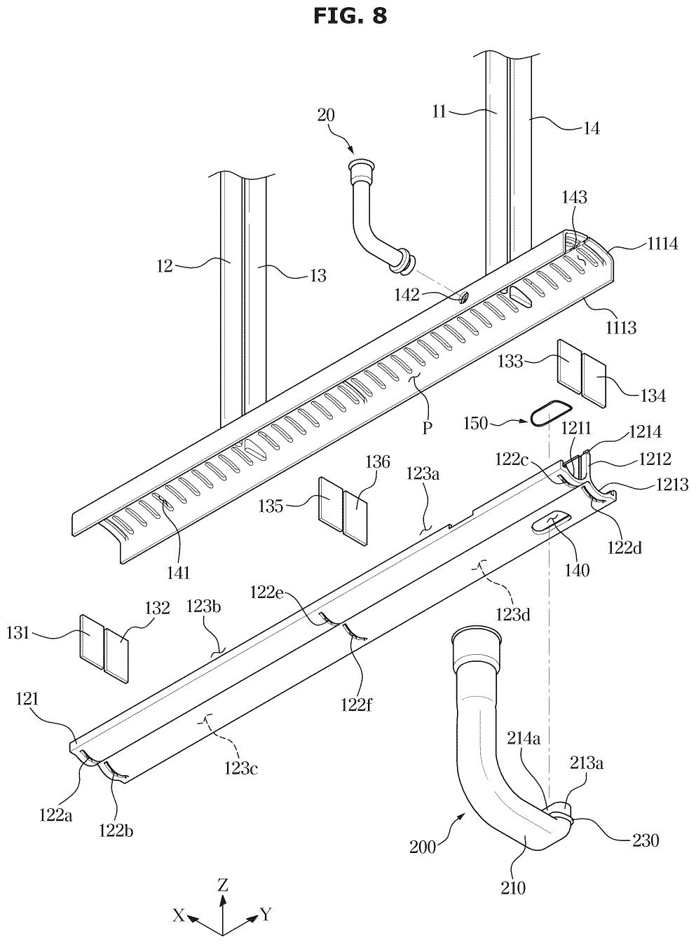

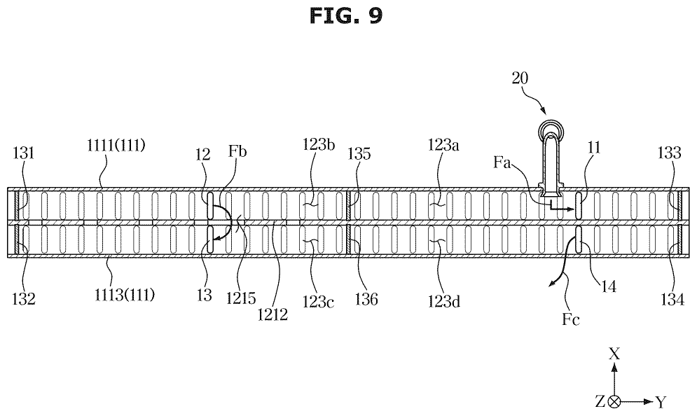

FIG. 7 is a perspective view illustrating various heat exchange tubes and a lower header in a heat exchanger according to various embodiments. FIG. 8 is an exploded perspective view of the lower header of FIG. 7 according to various embodiments. FIG. 9 is a cross-sectional view, taken along line C-C′ of FIG. 7 and viewed from below (−Z direction) according to various embodiments.

Referring to FIGS. 7, 8 and 9 (which may be referred to as FIGS. 7 to 9), the lower header 100 of the heat exchanger 2 may include a lower body 120, and a lower cover 110 detachably coupled to the lower body 120. The lower cover 110 may also be referred to as a first header 110, and the lower body 120 may also be referred to as a second header 120. Hereinafter, the lower cover 110 will be referred to as the first header 110 and the lower body 120 will be referred to as the second header 120.

The second header 120 may include a second header housing 121 forming an appearance, a first row 1211 forming a front side in +X direction of the second header 120 as a part of the second header housing 121, a second row 1213 forming a rear side in −X direction of the second header 120 as another part of the second header housing 121, and a second header partition wall 1212 formed between the first row 1211 of the second header 120 and the second row 1213 of the second header 120 as another part of the second header housing 121, the second header partition wall 1212 extending upward (+Z direction).

The second header housing 121 may extend in the left-right direction (+Y and −Y directions). For example, the first row 1211 of the second header 120 and the second row 1213 of the second header 120 may be formed to be convex downward (−Z direction). The second header partition wall 1212 may also extend in the left-right direction (+Y and −Y directions).

According to coupling of the second header 120 and the first header 110, the first row 1211 and the second header partition wall 1212 of the second header 120 may form an inlet chamber 123a and a first lower chamber 123b together with the first header 110.

In other words, the inlet chamber 123a and the first lower chamber 123b may be defined as a space surrounded by the first row 1211 and the second header partition wall 1212 of the second header 120 and the first header 110. A part of a first header chamber formed by a first header housing 111 may also be defined as the inlet chamber 123a and the first lower chamber 123b, which will be described in greater detail below.

According to coupling of the second header 120 and the first header 110, the second row 1213 and the second header partition wall 1212 of the second header 120 may form a second lower chamber 123c and an outlet chamber 123d together with the first header 110.

In other words, the second lower chamber 123c and the outlet chamber 123d may be defined as a space surrounded by the second row 1213 and the second header partition wall 1212 of the second header 120 and the first header 110. Another part of the first header chamber formed by the first header housing 111 may also be defined as the second lower chamber 123c and the outlet chamber 123d, which will be described in greater detail below.

The second header partition wall 1212 may partition the inlet chamber 123a and the first lower chamber 123b from the second lower chamber 123c and the outlet chamber 123d.

The second header partition wall 1212 may include a second header partition wall hole 1215. The second header partition hole 1215 may be formed to communicate the first lower chamber 123b with the second lower chamber 123c. The second header partition hole 1215 may not communicate the inlet chamber 123a with the outlet chamber 123d. Accordingly, a refrigerant flowing in the first lower chamber 123b may pass through the second header partition hole 1215 and flow to the second lower chamber 123c.

The second header 120 may include a second header coupling rib 1214 formed in the second header partition wall 1212. The second header coupling rib 1214 may protrude upward (+Z direction) from the second header partition wall 1212.

The second header coupling rib 1214 may extend along the second header partition wall 1212 in a longitudinal direction of the second header partition wall 1212. By inserting the second header coupling rib 1214 into a first header coupling groove 143 (which will be described in greater detail below) of the first header 110, the second header 120 may be coupled to the first header 110.

In the first row 1211 of the second header 120, a partition baffle coupling groove 122a, 122c, and 122e to which the partition baffle 131, 133, and 135 is coupled may be formed. The partition baffle coupling groove 122a, 122c, and 122e may include a plurality of partition baffle coupling grooves 122a, 122c, and 122e.

For example, the partition baffle coupling grooves 122a, 122c, and 122e may be formed respectively at one end of the first row 1211 of the second header 120, at another end of the first row 1211 of the second header 120, and between the one end and other end of the first row 1211 of the second header 120 (in the order of 122a, 122c, and 122e). Accordingly, the partition baffles 131, 133, and 135 may be spaced apart from each other and coupled to the first row 1211 of the second header 120.

For example, a space formed by the partition baffle 133 coupled to one end of the first row 1211 of the second header 120 and the partition baffle 135 positioned between the one end and other end of the first row 1211 of the second header 120, the partition baffle 133 and the partition baffle 135 being spaced apart from each other, may be defined as the inlet chamber 123a.

For example, a space formed by the partition baffle 131 coupled to the other end of the first row 1211 of the second header 120 and the partition baffle 135 positioned between the one end and other end of the first row 1211 of the second header 120, the partition baffle 131 and the partition baffle 135 being spaced apart from each other, may be defined as the first lower chamber 123b.

In the second row 1213 of the second header 120, a partition baffle coupling groove 122b, 122d, and 122f that is coupled to the partition baffle 132, 134, and 136 may be formed. The partition baffle coupling groove 122b, 122d, and 122f may include a plurality of partition baffle coupling grooves 122b, 122d, and 122f.

For example, the partition baffle coupling grooves 122b, 122d, and 122f may be formed respectively at one end of the second row 1213 of the second header 120, at another end of the second row 1213 of the second header 120, and between the one end and other end of the second row 1213 of the second header 120 (in the order of 122d, 122b, and 122f). Accordingly, the partition baffles 132, 134, and 136 may be spaced apart from each other and coupled to the second row 1213 of the second header 120.

For example, a space formed by the partition baffle 134 coupled to one end of the second row 1213 of the second header 120 and the partition baffle 136 positioned between the one end and other end of the second row 1213 of the second header 120, the partition baffle 134 and the partition baffle 136 being spaced apart from each other, may be defined as the outlet chamber 123d.

For example, a space formed by the partition baffle 132 coupled to the other end of the second row 1213 of the second header 120 and the partition baffle 136 positioned between the one end and other end of the second row 1213 of the second header 120, the partition baffle 132 and the partition baffle 136 being spaced apart from each other, may be defined as the second lower chamber 123c.

Because the second header partition wall 1212 partitions the inlet chamber 123a and the first lower chamber 123b from the second lower chamber 123c and the outlet chamber 123d, as a result, the inlet chamber 123a, the first lower chamber 123b, the second lower chamber 123, and the outlet chamber 123d may be partitioned from each other.

The first header 110 may include a first header coupling groove 143 into which the second header coupling rib 1214 of the second header 120 is inserted. By inserting the second header coupling rib 1212 into the first header coupling groove 143, the second header 120 may be coupled to the first header 110.

The first header 110 may include a lower tube hole 141 formed in an upper portion 1114 of the first header 110. A plurality of lower tube holes 141 may be provided. The plurality of lower tube holes 141 may penetrate the first header 110 and communicate with an internal space formed by coupling of the first header 110 and the second header 120.

According to coupling of the plurality of heat-exchange tubes 10 and the lower header 100, the plurality of lower tube holes 141 may communicate with the insides of the plurality of heat-exchange tubes 10.

Some of the plurality of lower tube holes 141 may include first row lower tube holes 141 arranged in a first row 1111 of the first header 110 along a longitudinal direction of the first header 110. A remaining part of the plurality of lower tube holes 141 may include second row lower tube holes 141 arranged in a second row 1113 of the first header 110 along the longitudinal direction of the first header 110.

For example, the first tube 11 may be coupled to the first header 110 and communicate with the first row lower tube hole 141 communicating with the inlet chamber 123a among the first row lower tube holes 141. For example, the second tube 12 may be coupled to the first header 110 and communicate with the first row lower tube hole 141 communicating with the first lower chamber 123b among the first row lower tube holes 141.

For example, the third tube 13 may be coupled to the first header 110 and communicate with the second row lower tube hole 141 communicating with the second lower chamber 123c among the second row lower tube holes 141. For example, the fourth tube 14 may be coupled to the first header 110 and communicate with the second row lower tube hole 141 communicating with the outlet chamber 123d among the first row lower tube holes 141.

The first header 110 may include an inlet pipe inserting hole 142 in which the inlet pipe 20 is inserted. For example, the inlet pipe inserting hole 142 may be formed in the first row 1111 of the first header 110 and communicate with the inlet chamber 123a. The inlet pipe 20 may be inserted in the inlet pipe inserting hole 142 and supply a refrigerant to the inlet chamber 123a.

The second header 120 may include a hole 140 in which the outlet pipe 200 is inserted. For example, the hole 140 may penetrate the second header housing 121 and communicate with the outlet chamber 123d.

For example, the hole 140 may be formed in the second row 1213 of the second header 120 and communicate with the outlet chamber 123b. For example, the hole 140 may be formed in a lower portion of the second row 1213 of the second header 120. The outlet pipe 200 may be inserted in the hole 140 and communicate with the outlet chamber 123d.

The heat exchanger 2 may include a solder ring (also referred to as a cover ring) 150 that covers an inner boundary b1 at which an inner surface 1231a of the second header 120 where the hole 140 is formed is in contact with an outer surface of the outlet pipe 200. The solder ring 150 may prevent and/or reduce a phenomenon that a refrigerant accommodated in the outlet chamber 123d leaks to the outside S through a penetration surface b3 of the hole 140 and a phenomenon that the refrigerant leaks directly to the outside S through the hole 140 not via the outlet pipe 200. Details about the solder ring 150 will be described in greater detail below.

Hereinafter, a flow of a refrigerant in the heat exchanger 2 will be briefly described.

The inlet pipe 20 may supply a refrigerant to the inlet chamber 123a of the lower header 100 (Fa). The supplied refrigerant may be supplied to the first tube 11 from the inlet chamber 123a and exchange heat with air (F1).

The refrigerant flowing in the first tube 11 may flow to the first upper chamber 312a of the upper header 300. The refrigerant flowed to the first upper chamber 312a may be transferred to the second tube 12 (F12) and flow to the first lower chamber 123b of the lower header 100 (F2).

The refrigerant flowed to the first lower chamber 123b may flow to the second lower chamber 123c through the second header partition wall hole 1215 (Fb). The refrigerant flowed to the second lower chamber 123c may flow to the second upper chamber 312b of the upper header 300 through the third tube 13 (F3).

Thereafter, the refrigerant may flow in the second upper chamber 312b (F34) and move to the outlet chamber 123d of the lower header 100 through the fourth tube 14 (F4). The refrigerant moved to the outlet chamber 123d may be discharged to the compressor of the heat exchanger 2 through the outlet pipe 200 (Fc).

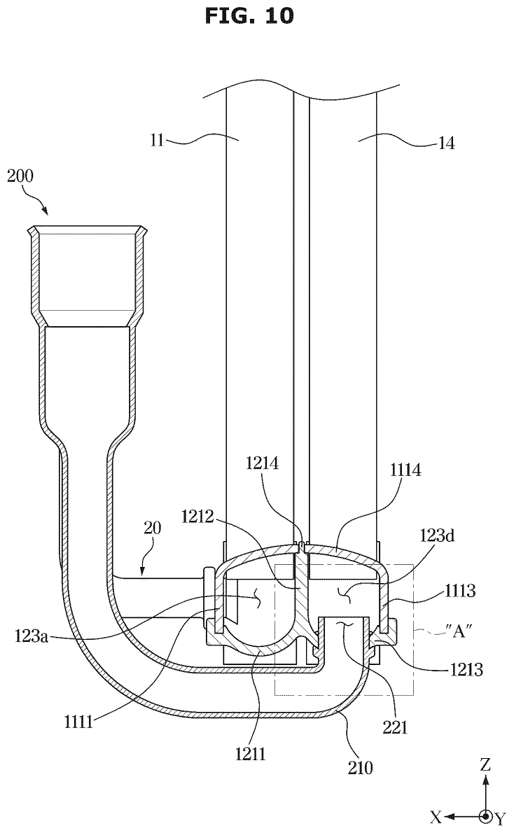

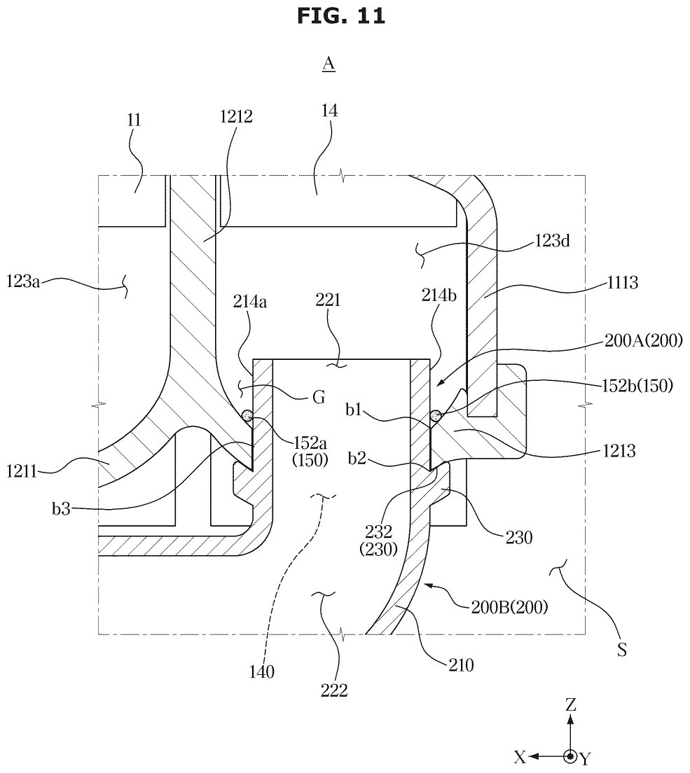

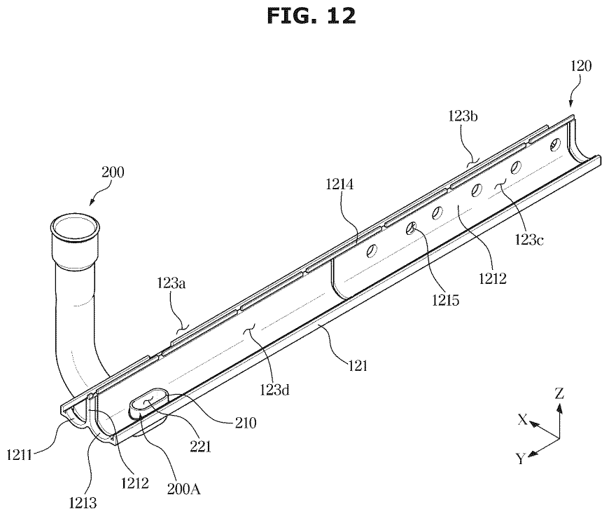

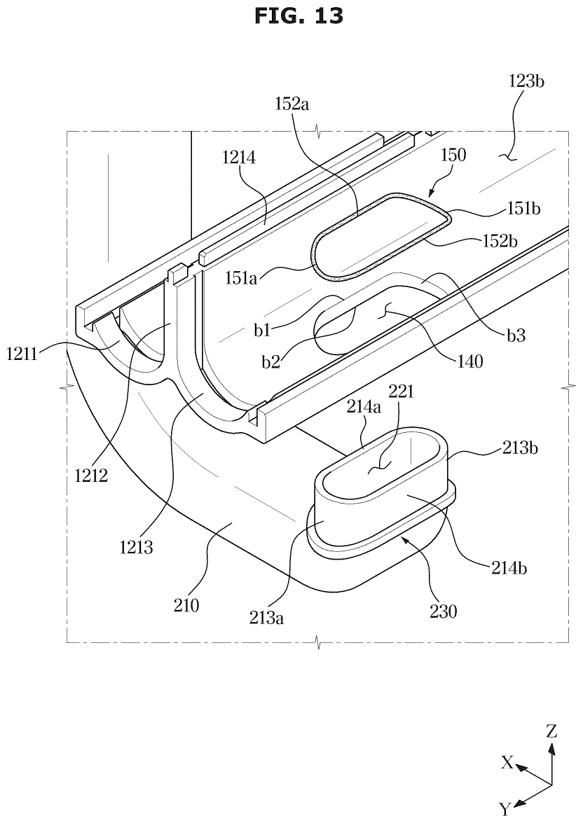

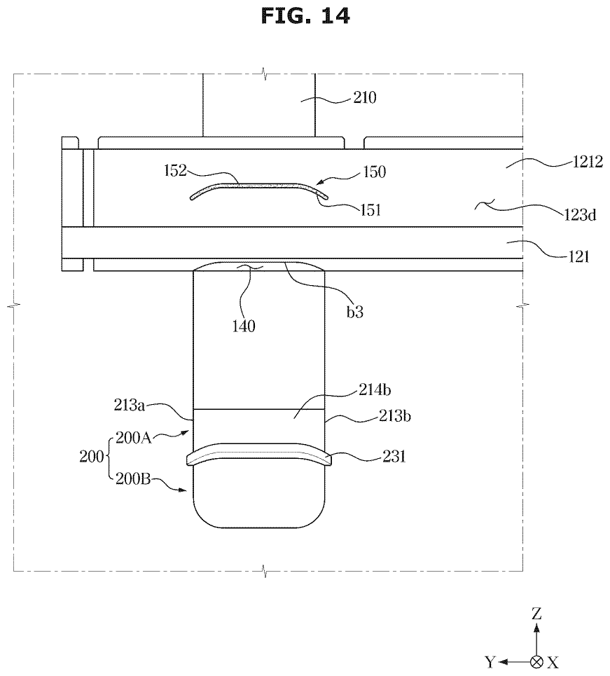

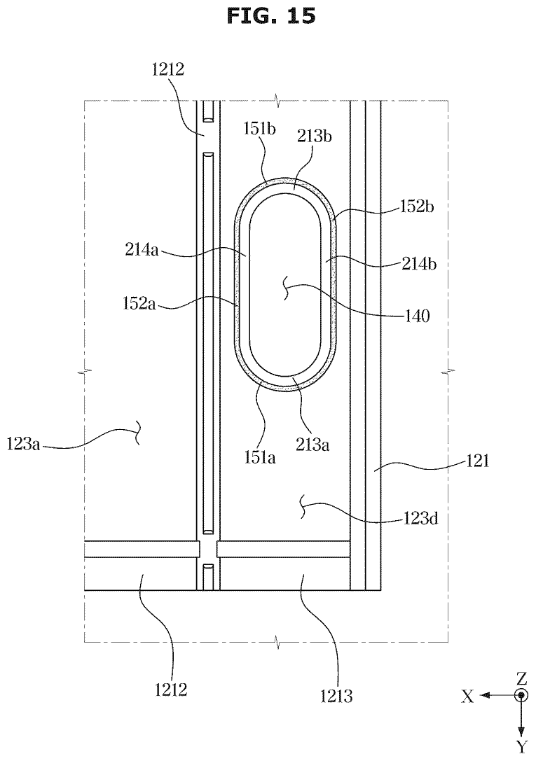

FIG. 10 is a cross-sectional view, taken along line D-D′ of FIG. 7 according to various embodiments. FIG. 11 is an enlarged view of an area A of FIG. 10 according to various embodiments. FIG. 12 is a perspective view illustrating an outlet pipe, a second header, and a solder ring in a heat exchanger according to various embodiments. FIG. 13 is a partial exploded perspective view showing an outlet pipe, a second header, and a solder ring in a heat exchanger according to various embodiments. FIG. 14 is a diagram illustrating a side view of FIG. 13 according to various embodiments. FIG. 15 is a diagram illustrating a top view of FIG. 13 according to various embodiments.

Referring to FIGS. 10, 11, 12, 13, 14 and 15 (which may be referred to as FIGS. 10 to 15), the outlet pipe 200 may include an outlet pipe body 210 forming an appearance. The outlet pipe 200 may include an inlet hole 221 formed at one end of the outlet pipe 200, wherein a refrigerant flows into a flow path 222 of the outlet pipe 200 through the inlet hole 221.

The hole 140 may penetrate the second header 120. For example, the hole 140 may be formed in a space surrounded by the penetration surface b3 formed by penetrating the second header 120.

The outlet pipe 200 may be coupled to second header 120 by passing the outlet pipe body 210 through the hole 140 such that the inlet hole 221 communicates with the outlet chamber 123d. For example, because the hole 140 is formed in the lower portion of the second header 120, the outlet pipe 200 may include a bent shape to be inserted into the hole 140.

The outlet pipe 200 may include a first outlet pipe 200A positioned inside the outlet chamber 123d, and a second outlet pipe 200B extending from the first outlet pipe 200A.

For example, the second outlet pipe 200B may be a part of the outlet pipe 200 excluding the first outlet pipe 200A.

For example, the first outlet pipe 200A positioned inside the outlet chamber 123d may be a part of the outlet pipe 200, which is not in contact with the penetration surface b3 and is positioned inside the outlet chamber 123d.

For example, the second outlet pipe 200B excluding the first outlet pipe 200A may include another part of the outlet pipe 200, which is in contact with the penetration surface b3, and a remaining part of the outlet pipe 200, which extends from the first outlet pipe 200A to the outside S.

For example, the outlet pipe 200 may be formed such that the cross-section includes a substantially oval shape.

The first outlet pipe 200A may include a pair of flat parts 214 and a pair of curved parts 213 connected the pair of flat parts 214 to each other.

The pair of flat parts 214 may include a first flat part 214a and a second flat part 214b spaced from the first flat part 214a. The outlet pipe 200 may be coupled to the second header 120 such that the flat parts 214 are positioned to extend in a direction parallel to the longitudinal direction of the second header 120.

The curved parts 213 may include a first curved part 213a connecting one ends of the pair of flat parts 214 to each other, and a second curved part 213b connecting other ends of the pair of flat parts 214 to each other. For example, the pair of curved parts 213 may be formed to be convex in a radial direction of the cross-section of the outlet pipe 200.

The pair of flat parts 214 and the pair of curved parts 213 may be connected to each other to form the inlet hole 221. For example, the ends of the flat parts 214 or the ends of the curved parts 213 may face the first header 110.

As described above, the inner surface 1231a of the second header 120 may be in contact with the outer surface of the first outlet pipe 200A to form the inner boundary b1. For example, the inner boundary b1 may be an upper (+Z direction) end of the penetration surface b3.

An outer surface of the second outlet pipe 200B may be in contact with an outer surface of the second header 120 to form an outer boundary b2. For example, the outer boundary b2 may be a lower (−Z direction) end of the penetration surface b3.

The solder ring 150 may cover the inner boundary b1. The solder ring 150 may include a pair of long side portions 152, and a pair of curved portions 151 connecting the pair of long side portions 152 to each other.

The pair of long side portions 152 may include a first long side portion 152a, and a second long side portion 152b spaced apart from the first long side portion 152a. The solder ring 150 may be positioned in the outlet chamber 123d such that the long side portions 152 are positioned to extend in a direction parallel to the longitudinal direction of the second header 120.

The curved portions 151 may include a first curved portion 151a connecting one ends of the pair of long side portions 152 to each other, and a second curved portion 151b connecting other ends of the pair of long side portions 152 to each other.

The solder ring 150 may be positioned along the outer surface of the first outlet pipe 200A. The solder ring 150 may cover a part of the outer surface of the first outlet pipe 200A.

For example, the solder ring 150 may be inserted in a boundary groove G formed by a contact of the inner surface 1231a of the second header 120 with the outer surface of the first outlet pipe 200A.

For example, the solder ring 150 may be positioned in the outlet chamber 123d in such a way as to be in contact with both the inner surface 1231a of the second header 120 and the outer surface of the first outlet pipe 200A. For example, the solder ring 150 may be positioned such that the first long side portion 152a is in contact with the first flat part 214a of the first outlet pipe 200A and the inner surface 1231a of the second header 120 and the second long side portion 152b is in contact with the second flat part 214b and the inner surface 1231a of the second header 120.

For example, the solder ring 150 may be positioned such that the first curved portion 151a is in contact with the first curved part 213a of the first outlet pipe 200A and the inner surface 1231a of the second header 120 and the second curved portion 151b is in contact with the second curved part 213b of the first outlet pipe 200A and the inner surface 1231a of the second header 120.

For example, the solder ring 150 may include a filler metal. As described above, the outlet pipe 200 may be coupled to the second header 120 by a brazing process.

The brazing process may be a method of bonding base metals by heating the base metals and a filler metal together and melting and solidifying the filler metal. In this case, the solder ring 150 may act as a filler metal. Accordingly, a melting point of the solder ring 150 may be lower than melting points of the second header 120 and the outlet pipe 200.

In an embodiment of the disclosure, after the second header 120, the outlet pipe 200, and the solder ring 150 are positioned for brazing coupling, a caulking process of forming a catching protrusion 241 may be performed before the second header 120, the outlet pipe 200, and the solder ring 150 are heated. Details about the caulking process will be described in greater detail below.

Because the solder ring 150 covers the inner boundary b1, a phenomenon that a refrigerant accommodated in the outlet chamber 123d leaks to the outside S through the penetration surface b3 of the hole 140 and a phenomenon that the refrigerant leaks directly to the outside S through the hole 140 not via the outlet pipe 200 may be prevented/reduced.

The second outlet pipe 200B may extend from the first outlet pipe 200A to the outside S through the hole 140.

The second outlet pipe 200B may include a lead 230 formed to cover the outer boundary b2. The lead 230 may be formed along the outer surface of the second outlet pipe 200B. The lead 230 may protrude from the outer surface of the second outlet pipe 200B in a radial direction of the second outlet pipe 200B.

One surface 232 of the lead 230 toward the second header 120 may cover the outer boundary b2 from the outer surface of the second header 120. The one surface 232 of the lead 230 toward the second header 120 may be in contact with the lower portion of the second header 120 where the outer boundary b2 is formed.

Because the outer boundary b2 is covered by the lead 230, a phenomenon that a refrigerant accommodated in the outlet chamber 123d leaks to the outside S through the penetration surface b3 of the hole 140 and a phenomenon that the refrigerant leaks directly to the outside S through the hole 140 not via the outlet pipe 200 may be additionally prevented/blocked.

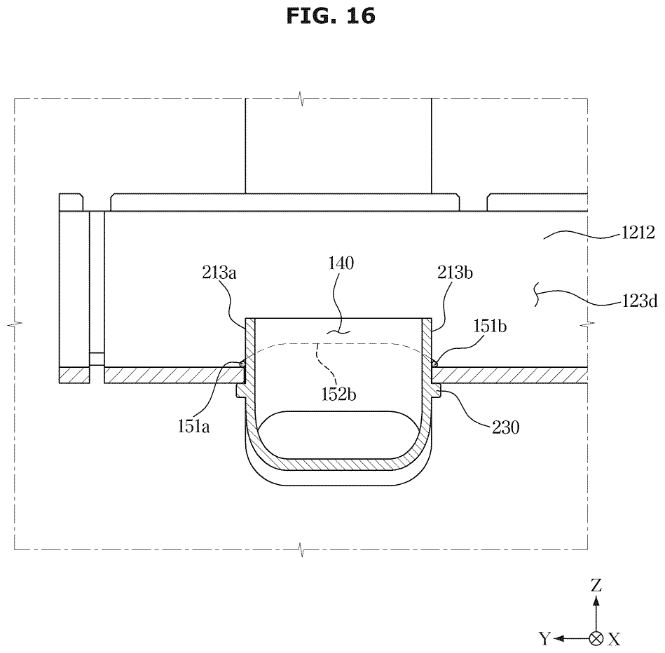

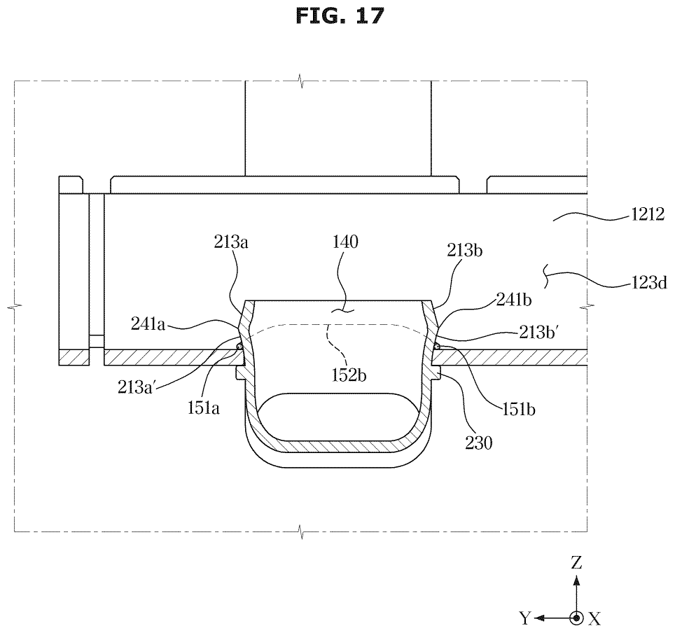

FIG. 16 is a cross-sectional view of FIG. 12 according to various embodiments. FIG. 17 is a diagram illustrating a state in which a catching member is formed in a first outlet pipe in FIG. 16 according to various embodiments.

Referring to FIGS. 16 and 17, as described above, the outlet pipe 200 may be coupled to the second header 120 using the solder ring 150 as a filler metal through a brazing process.

The first outlet pipe 200A may include a catching protrusion 241 protruding from the outer surface of the first outlet pipe 200A in the radial direction of the first outlet pipe 200A.

More specifically, after the first outlet pipe 200A is positioned inside the outlet chamber 123d by passing through the hole 140 and the solder ring 150 is positioned to cover the inner boundary b1 for a brazing process, a caulking process for forming the catching protrusion 241 in the first outlet pipe 200A may be performed.

For example, the caulking process may be a process of forming the catching protrusion 241 by applying a force to a part of the first outlet pipe 200A in the radial direction of the first outlet pipe 200A to deform the first outlet pipe 200A.

For example, the catching protrusion 241 may protrude toward a direction (+Y and −Y directions) parallel to a direction in which the second header 120 extends. For example, the catching protrusion 241 may include a plurality of catching protrusions 241a and 241b. The plurality of catching protrusions 241a and 241b may be arranged to face each other. The plurality of catching protrusions 241a and 241b may be arranged together on an extension line parallel to the direction in which the second header 120 extends.

By the caulking process, a maximum length of the first outlet pipe 200A in the direction in which the second header 120 extends may become greater than a length of the hole 140 in the direction in which the second header 120 extends.

The maximum length of the first outlet pipe 200A in the direction in which the second header 120 extends may be a length from one end of one of the plurality of catching protrusions 241a and 241b to another end of another one. Accordingly, because the first outlet pipe 200A is prevented or resists departing from the outlet chamber 123d, the brazing process may be stably performed.

For example, the solder ring 150 may be positioned closer to the inner surface 1231a of the second header 120 than the catching protrusion 241. In other words, the solder ring 150 may be positioned between the hole 140 and the catching protrusion 241.

A length of the solder ring 150 in the direction in which the second header 120 extends may be smaller than the maximum length of the first outlet pipe 200A in the direction in which the second header 120 extends. Accordingly, the solder ring 150 may stably cover the inner boundary b1 without departing from the first outlet pipe 200A. Therefore, the brazing process may be stably performed.

For example, the catching protrusion 241 may be formed in the curved parts 213 of the first outlet pipe 200A. The plurality of catching protrusions 241a and 241b may be respectively formed in the pair of curved parts 213.

As the catching protrusions 241 are formed in the curved parts 213 through the caulking process, the curved parts 213 may include inclined surfaces 213a′ and 213b′ inclined by the catching protrusions 241 protruding. In other words, the curved parts 213 may include the inclined surfaces 213a′ and 213b′ extending toward the catching protrusions 241 from a boundary line where the curved parts 213 are in contact with the inner surface 1231a of the second header 120.

Because the catching protrusions 241 protrude at an upper position (+Z direction) than the solder ring 150 in the radial direction of the first outlet pipe 200A, the inclined surfaces 213a′ and 213b′ may be inclined toward the soldering ring 150.

Therefore, the solder ring 150 may be pressed by the inclined surfaces 213a′ and 213b′ to be pressed and supported toward the inner surface 1231a of the second header 120. Accordingly, the solder ring 150 may be prevented/reduced from being spaced apart from the inner surface 1231a of the second header 120 and from departing from the first outlet pipe 200A.

For example, the catching protrusions 241 may be formed in the curved parts 213 at a height at which the flat parts 214 are in contact with the inner surface 1231a of the second header 120, in one end of the first outlet pipe 200A toward the outlet chamber 123d.

Because the second row 1213 of the second header 120 includes a shape that is convex downward (−Z direction) (see FIGS. 14 and 16), the curved portions 151 of the solder ring 150 may be inclined downward (−Z direction) and located at a lower position (−Z direction) than the long side portions 152 to cover the hole 140 formed in the second row 1213 of the second header 120.

Also, because the catching protrusions 241 are formed in the curved parts 213 of the first outlet pipe 200A being in contact with the curved portions 151, the catching protrusions 241 formed in the curved parts 213 may be located at an upper position (+Z direction) than a position of the inner boundary b1 formed by the curved parts 213 and the inner surface 1231b of the second header 120. Accordingly, because the catching protrusions 241 are formed at an upper position (+Z direction) than the solder ring 150 covering the inner boundary b1, the solder ring 150 may be effectively prevented or inhibited from departing from the first outlet pipe 200A.

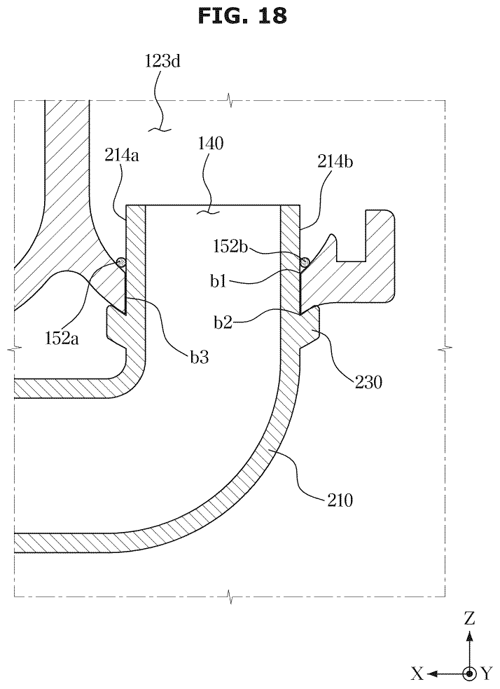

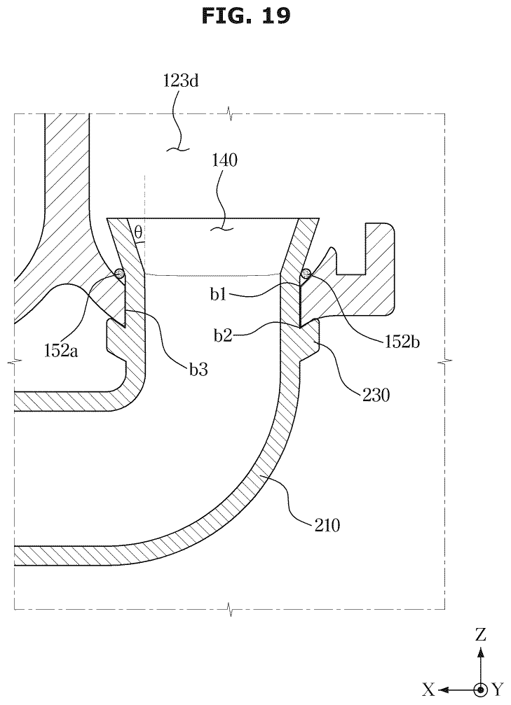

FIG. 18 is a cross-sectional view of FIG. 12 according to various embodiments. FIG. 19 is a cross-sectional view illustrating a state in which a pair of flat parts are processed to be inclined in FIG. 18 according to various embodiments.

Referring to FIGS. 18 and 19, each of the pair of flat parts 214 may be inclined in an outward direction of the first outlet pipe 200A. More for example, the pair of flat parts 214 may be bent in the outward direction of the first outlet pipe 200A.

According to forming of the catching protrusions 241 in the pair of curved parts 213 by caulking, the flat parts 214 may receive a tensile force in a direction toward the respective curved parts 213. According to beginning of heating for a brazing process while the flat parts 214 receives a tensile force, the flat parts 214 may be damaged. By deforming the flat parts 214 to be inclined in the outward direction of the first outlet pipe 200A, such damage may be prevented and/or reduced.

Also, because the flat parts 214 are inclined in the outward direction of the first outlet pipe 200A, departure of the solder ring 150 may be more effectively prevented or inhibited.

Thereafter, the outlet pipe 200, the second header 120, and the solder ring 150 may be heated through a brazing process to stably couple the outlet pipe 200 to the second header 120.

For example, according to an embodiment of the disclosure, because a space for arranging a separate coupling block for coupling the outlet pipe 200 to the second header 120 is not required, the heat exchanger 2 with improved space utilization may be provided.

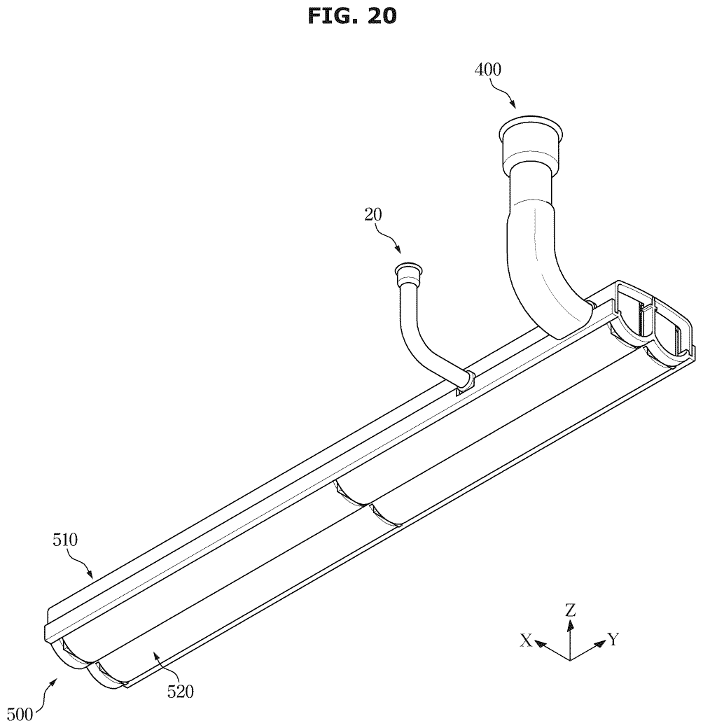

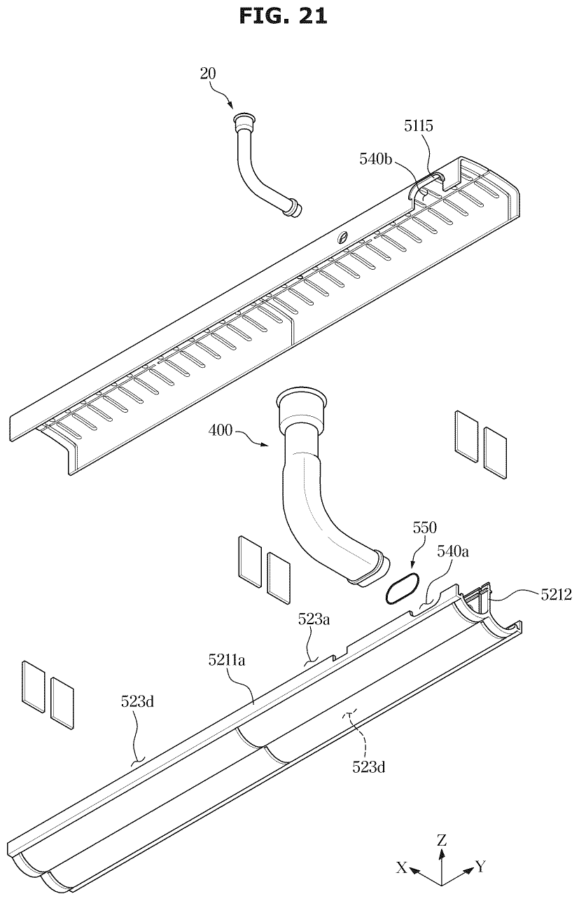

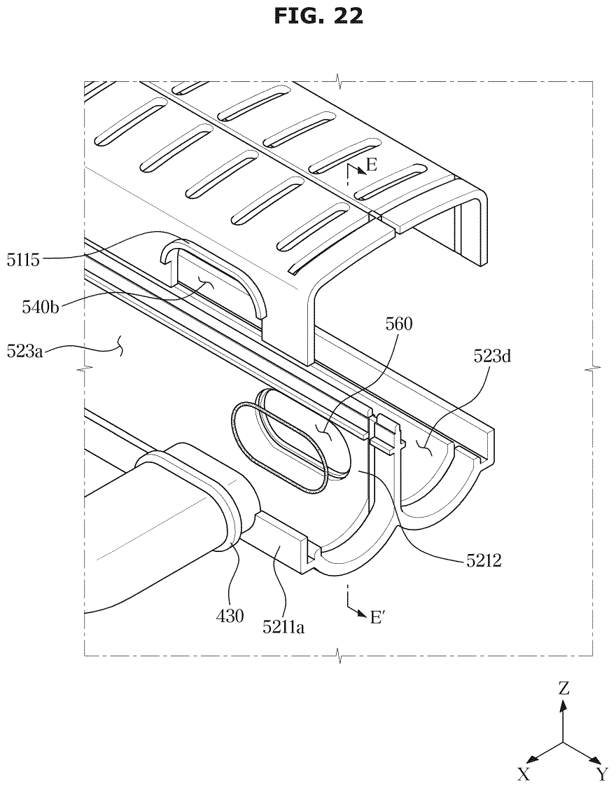

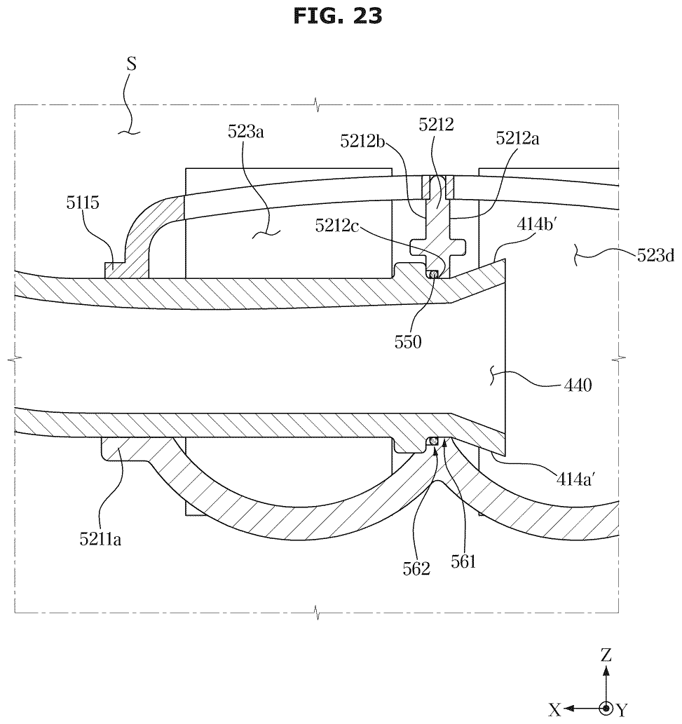

FIG. 20 is a perspective view illustrating an outlet pipe, an inlet pipe, a second header, and a solder ring in a heat exchanger according to various embodiments. FIG. 21 is an exploded perspective view of FIG. 20 according to various embodiments. FIG. 22 is a partial exploded perspective view of FIG. 20 viewed from another angle according to various embodiments. FIG. 23 is a cross-sectional view taken along line E-E′ of FIG. 22, after components of FIG. 22 are combined according to various embodiments. Hereinafter, descriptions about content overlapping with the above content may not be repeated.

Referring to FIGS. 20, 21, 22 and 23 (which may be referred to as FIGS. 20 to 23), an outlet pipe 400 may be coupled to a second header 520.

The second header 520 may include a first through hole 540a that opens toward the front direction. A first header 510 may include a second through hole 540b that opens toward the front direction.

According to coupling of the first header 510 and the second header 520, the first through hole 540a may communicate with the second through hole 520b to form a through hole 540. The through hole 540 may communicate with an inlet chamber 523a.

The outlet pipe 400 may be inserted into an inside of a lower header 500 through the through hole 540.

The outlet pipe 400 inserted through the through hole 540 may pass through the inlet chamber 523a without communicating with the inlet chamber 523a, which will be described in greater detail below. The outlet pipe 400 may pass through a hole 560 formed in a second header partition wall 5212 such that one end at which an inlet hole 440 is formed communicates with the outlet chamber 523d. As a result, an inside of the outlet pipe 400 may communicate with the outlet chamber 523d.

The first header 510 may include a first lead 5115 that covers an outer circumference of the second through hole 540b. In other words, the first lead 5115 may be formed to cover a first boundary formed by a contact of an outer surface of a second outlet pipe 400B, positioned outside the first header 510, with the inner surface of the first header 510.

The second header 520 may include a second lead 5211a that covers an outer circumference of the first through hole 540a. In other words, the second lead 5211a may be formed to cover a second boundary formed by a contact of the outer surface of the second outlet pipe 400B, positioned in the outside, with the inner surface of the second header 520.

According to coupling of the first header 510 and the second header 520, the first lead 5115 and the second lead 5211a may be connected to each other to form the leads 5115 and 5211a. According to coupling of the first header 510 and the second header 520, the first boundary and the second boundary may be connected to each other to form a boundary which is an outer circumference of the through hole 540. The boundary may be formed in the respective outer surfaces of the first header 510 and the second header 520.

According to coupling of the first header 510 and the second header 520, the leads 5115 and 5211a may cover the outer circumference of the through hole 540. According to coupling of the outlet pipe 400 and the lower header 500, the leads 5115 and 5211a may be arranged to surround the outer circumference of the outlet pipe 400. In other words, the leads 5115 and 5211a may be formed to cover a boundary formed by a contact of the outer surface of the second outlet pipe 400B, positioned in the outside, with the inner surface of the second header 520. Accordingly, a phenomenon in which a refrigerant flowing in the inlet chamber 20 leaks to the outside through the through hole 540 may be prevented and/or reduced.

The second header partition wall (also referred to as the partition wall) 5212 may include the hole 560 communicating the inlet chamber 523a with the outlet chamber 523d. The outlet pipe 400 may communicate with the outlet chamber 523d by passing through the inlet chamber 523a and being inserted into the hole 560.

The hole 560 may include a first groove 561 formed in one surface 5212a of the partition wall 5212 toward the outlet chamber 523d. The hole 560 may include a second groove 562 formed in another surface 5212b of the partition wall 5212. The other surface 5212b of the partition wall 5212 may be one surface 5212b of the partition wall 5212 toward the inlet chamber 523a.

The first groove 561 and the second groove 562 may communicate with each other to form the hole 560.

For example, an outer diameter of the second groove 562 may be larger than an outer diameter of the first groove 561. Accordingly, a through surface formed in the partition wall 5212 and surrounding the hole 560 may be bent at a location where the first groove 561 and the second groove 562 communicate with each other. That is, the partition wall 5212 may include a bent portion formed at the location where the first groove 561 and the second groove 562 communicate with each other.

A solder ring 550 may be inserted in the bent portion. The solder ring 550 may be positioned along an outer circumference of the second outlet pipe 400B.

The outlet pipe 400 may include a pipe lead 430. For example, the pipe lead 430 may extend from the outer surface of the second outlet pipe 400B in a radial direction of the second outlet pipe 400B. The pipe lead 430 may be formed along the outer circumference of the second outlet pipe 400B.

The pipe lead 430 may be in contact with the surface 5212b of the second header partition wall 5212 toward the inlet chamber 523a. As described above, the surface 5212b of the second header partition wall 5212 toward the inlet chamber 523a may be the other surface of the second header partition wall 5212 toward the outlet chamber 523d.

In other words, the pipe lead 430 may be formed to cover a partition wall boundary 5212c formed by a contact of the outer surface of the second outlet pipe 400B with the other surface 5212b of the partition wall 5212.

Because the pipe lead 430 covers the partition wall boundary 5212c, a phenomenon in which a refrigerant flowing in the outlet chamber 523d leaks out through the hole 560 not via the outlet pipe 400 may be prevented and/or reduced. Also, the solder ring 550 may be stably accommodated in the bent portion.

A first outlet pipe 400A may include a catching protrusion 441 formed in curved parts 413 and protruding from the first outlet pipe 400A in a radial direction of the first outlet pipe 400A. Also, flat parts (414; 414a′ and 414b′) of the first outlet pipe 400A may be formed to be inclined in the radial direction of the first outlet pipe 400A. Accordingly, the first outlet pipe 400A may be prevented or inhibited from departing from the outlet chamber 523d, and a brazing process may be stably performed.

That is, according to an embodiment of the disclosure, because a space for arranging a separate coupling block for coupling the outlet pipe 400 to the second header 520 is not required, a heat exchanger 3 with improved space utilization may be provided.

A heat exchanger according to an example embodiment may include: a header including a first header and a second header detachably coupled to the first header, the header forming an outlet chamber accommodating a refrigerant. The heat exchanger may include a heat-exchange tube connected to the first header, wherein the refrigerant is configured to flow through the heat-exchange tube and configured to exchange heat with air of the outside. The heat exchanger may include an outlet pipe inserted in a hole penetrating the second header and communicating with the outlet chamber, the outlet pipe being coupled to the second header by brazing and communicating with the outlet chamber and configured to discharge the refrigerant from the outlet chamber to the outside. The outlet pipe may include a first outlet pipe positioned in the outlet chamber and a second outlet pipe extending from the first outlet pipe to the outside. The first outlet pipe may include a catching protrusion protruding from an outer surface of the first outlet pipe in a radial direction of the first outlet pipe and configured to resist movement of the first outlet pipe departing from the outlet chamber.

The heat exchanger may further include a solder ring covering an inner boundary formed by a contact of an inner surface of the second header, forming the hole, with an outer surface of the first outlet pipe.

The solder ring may be positioned in the outlet chamber and in contact with the inner surface of the second header and the outer surface of the first outlet pipe.

The solder ring may be positioned closer to the inner surface of the second header than the catching protrusion.

The first outlet pipe may include a pair of flat parts extending in a direction parallel to a longitudinal direction of the second header. The first outlet pipe may include a curved part connecting the pair of flat parts to each other. The catching protrusion may be formed in the curved part.

The catching protrusion may be formed in the curved part at a height at which the flat parts are in contact with the inner surface of the second header, in one end of the first outlet pipe toward the outlet chamber.

The curved part may further include an inclined surface extending toward the catching protrusion from a boundary line where the curved part is in contact with the inner surface of the second header. The solder ring may be supported on the inclined surface and not spaced apart from the inner surface of the second header.

The pair of flat parts may be inclined in an outward direction of the first outlet pipe.

The solder ring may include a filler metal.

The outlet pipe may include a second outlet pipe extending from the first outlet pipe to the outside and passing through the hole. The second outlet pipe may include a lead covering an outer boundary formed by a contact of the outer surface of the second header, forming the hole, with an outer surface of the second outlet pipe.

The lead may protrude from the outer surface of the second header in a radial direction of the second header. One surface of the lead toward the second header may be in contact with the outer surface of the second header and cover the outer boundary from the outer surface of the second header.

A second header may include a partition wall in which a hole is formed, the partition wall protruding from an inner surface of the second header toward a first header and configured to partition an inside of a header into an outlet chamber and another chamber other than the outlet chamber. A second outlet pipe may extend from a first outlet pipe to outside passing through the another chamber than the outlet chamber.

The hole may include a first groove formed in one surface of the partition wall toward the outlet chamber. The hole may include a second groove formed in another surface of the partition wall, communicating with the first groove, and having a larger radius than a radius of the first groove. The heat exchanger may further include a solder ring inserted in a bent portion formed by the first groove and the second groove.

The second outlet pipe may include a lead covering a partition wall boundary formed by a contact of the other surface of the partition wall, forming the hole, with an outer surface of the second outlet pipe.

The first header may include a first lead covering a first boundary formed by a contact of the outer surface of the second outlet pipe positioned in the outside with the inner surface of the first header. The second header may include a second lead covering a second boundary formed by a contact of the outer surface of the second outlet pipe, positioned in the outside, with the inner surface of the second header. The first lead may be connected to the second lead by coupling of the first header and the second header.

A heat exchanger according to an example embodiment may include: a header forming an inlet chamber accommodating a refrigerant configured to flow thereto and an outlet chamber accommodating a refrigerant to be discharged to the outside. The heat exchanger may include a heat-exchange tube connected to the header, wherein the refrigerant is configured to flow through the heat-exchange tube and to exchange heat with air of the outside. The heat exchanger may include an inlet pipe in communication with the inlet chamber and configured to supply a refrigerant to the inlet chamber, and an outlet pipe coupled to the header by brazing and inserted in a hole penetrating the header and in communication with the outlet chamber and configured to discharge the refrigerant in the outlet chamber. The outlet pipe may include a first outlet pipe positioned in the outlet chamber and a second outlet pipe extending from the first outlet pipe to the outside. The first outlet pipe may include a catching protrusion protruding from an outer surface of the first outlet pipe in a radial direction of the first outlet pipe and configured to resist movement of the first outlet pipe from departing from the outlet chamber.

The heat exchanger may further include a solder ring configured to cover an inner boundary formed by a contact of an inner surface of the header, forming the hole, with an outer surface of the first outlet pipe. The solder ring may be positioned in the outlet chamber to be in contact with the inner surface of the header and the outer surface of the first outlet pipe.

A header may include a partition wall in which the hole is formed, the partition wall protruding from the inner surface of the header and configured to partition an inside of the header into an inlet chamber and an outlet chamber. The second outlet pipe may extend from the first outlet pipe communicating with the outlet chamber to the outside by passing through the inlet chamber.

The header may include a first header and a second header detachably coupled to the first header. The first header may include a first lead covering a first boundary formed by a contact of the outer surface of the second outlet pipe, positioned in the outside, with the inner surface of the first header. The second header may include a second lead covering a second boundary formed by a contact of the outer surface of the second outlet pipe, positioned in the outside, with the inner surface of the second header. The first header and the second header may be coupled to connect the first lead to the second lead.

An air conditioner according to an example embodiment may include: a housing including an inlet port into configured to draw air in, and an outlet port through which heat-exchanged air is discharged. The air conditioner may include a heat exchanger positioned inside the housing and configured to exchange heat with the drawn in air. The air conditioner may include a fan configured to operate to discharge heat-exchanged air to the outside. The heat exchanger may include a first header and a second header detachably coupled to the first header. The heat exchanger may include a header forming an outlet chamber accommodating a refrigerant. The heat exchanger may include a heat-exchange tube connected to the first header, wherein a refrigerant is configured to flow through the heat-exchange tube to exchange heat with air of the outside. The heat exchanger may include an outlet pipe inserted in a hole penetrating the second header and in communication with the outlet chamber, the outlet pipe being coupled to the second header by brazing and in communication with the outlet chamber and configured to discharge the refrigerant from the outlet chamber to the outside. The outlet pipe may include a first outlet pipe positioned in the outlet chamber and a second outlet pipe extending from the first outlet pipe to the outside. The first outlet pipe may include a catching protrusion protruding from an outer surface of the first outlet pipe in a radial direction of the first outlet pipe and configured to resist movement of the first outlet pipe from departing from the outlet chamber.

According to various example embodiments of the disclosure, because a separate coupling block for coupling the outlet pipe to the header is not included, space utilization may be improved.

According to various example embodiments disclosure, because the outlet pipe includes the catching protrusion, a phenomenon in which the outlet pipe departs from the header during a brazing process may be prevented or inhibited, and the brazing process may be stably performed.

According to various example embodiments of the disclosure, because the flat parts of the outlet pipe are inclined in the outward direction of the outlet pipe, a phenomenon in which one ends of the flat parts are damaged during the brazing process may be prevented/reduced.

According to various example embodiments of the disclosure, because a phenomenon in which the solder ring departs from the inner boundary formed by a contact of the inner surface of the second header with the outer surface of the outlet pipe is prevented/inhibited by the catching protrusion, the hole may be more effectively sealed.

While the disclosure has been illustrated and described with reference to various example embodiment, it will be understood that the disclosure is not limited to the above-described illustrative embodiments, and various modifications can be made by those skilled in the art without departing from the true spirit and full scope of the disclosure including the appended claims an their equivalents. It will also be understood that any of the embodiment(s) described herein may be used in conjunction with any other embodiment(s) described herein.

What is claimed is:

1. A heat exchanger comprising:
a header including a first header and a second header detachably coupled to the first header, the header forming an outlet chamber accommodating a refrigerant;
a heat-exchange tube connected to the first header, wherein the refrigerant is configured to flow through the heat-exchange tube to exchange heat with outside air; and
an outlet pipe inserted in a hole penetrating the second header and in communication with the outlet chamber, the outlet pipe being coupled to the second header by brazing and in communication with the outlet chamber and configured to discharge the refrigerant in the outlet chamber,
wherein the outlet pipe comprises a first outlet pipe positioned in the outlet chamber and a second outlet pipe extending from the first outlet pipe to the outside, and
the first outlet pipe comprises a catching protrusion protruding from an outer surface of the first outlet pipe in a radial direction of the first outlet pipe to resist movement of the first outlet pipe departing from the outlet chamber.

2. The heat exchanger of claim 1, further comprising a solder ring covering an inner boundary formed by a contact of an inner surface of the second header, forming the hole, with an outer surface of the first outlet pipe.

3. The heat exchanger of claim 2, wherein the solder ring is positioned in the outlet chamber and in contact with the inner surface of the second header and the outer surface of the first outlet pipe.

4. The heat exchanger of claim 3, wherein the solder ring is positioned closer to the inner surface of the second header than the catching protrusion.

5. The heat exchanger of claim 2, wherein:
the outlet pipe comprises:
a pair of flat parts extending in a direction parallel to a longitudinal direction of the second header, and
a curved part connecting the pair of flat parts to each other, and
the catching protrusion is formed in the curved part.

6. The heat exchanger of claim 5, wherein
the catching protrusion is formed in the curved part at a height at which the flat parts are in contact with the inner surface of the second header, with respect to one end of the first outlet pipe toward the outlet chamber.

7. The heat exchanger of claim 6, wherein
the curved part further comprises an inclined surface extending toward the catching protrusion from a boundary line where the curved part is in contact with the inner surface of the second header, and
the solder ring is supported on the inclined surface and not spaced apart from the inner surface of the second header.

8. The heat exchanger of claim 5, wherein each of the pair of flat parts is inclined in an outward direction of the first outlet pipe.

9. The heat exchanger of claim 3, wherein the soldering comprises a filler metal.

10. The heat exchanger of claim 2, wherein
the outlet pipe comprises a second outlet pipe extending from the first outlet pipe to the outside and passing through the hole, and
the second outlet pipe comprises a lead covering an outer boundary formed by a contact of the outer surface of the second header, forming the hole, with an outer surface of the second outlet pipe.

11. The heat exchanger of claim 10, wherein
the lead protrudes from the outer surface of the second header in a radial direction of the second header, and
one surface of the lead toward the second header is in contact with the outer surface of the second header to cover the outer boundary from an outer side of the second header.

12. The heat exchanger of claim 10, wherein
the second header comprises a partition wall in which the hole is formed, the partition wall protruding from the inner surface of the second header toward the first header and configured to partition an inside of the header into the outlet chamber and another chamber other than the outlet chamber, and
the second outlet pipe extends from the first outlet pipe to the outside passing through the another chamber than the outlet chamber.

13. The heat exchanger of claim 12, wherein
the hole comprises:
a first groove formed in one surface of the partition wall toward the outlet chamber, and
a second groove formed in another surface of the partition wall, communicating with the first groove, and having a larger radius than a radius of the first groove,
the heat exchanger further comprising a solder ring inserted in a bent portion formed by the first groove and the second groove.

14. The heat exchanger of claim 12, wherein
the second outlet pipe comprises a lead covering a partition wall boundary formed by a contact of another surface of the partition wall, forming the hole, with an outer surface of the second outlet pipe.

15. The heat exchanger of claim 12, wherein
the first header comprises a first lead covering a first boundary formed by a contact of the outer surface of the second outlet pipe, positioned in the outside, with the inner surface of the first header,
the second header comprises a second lead covering a second boundary formed by a contact of the outer surface of the second outlet pipe, positioned in the outside, with the inner surface of the second header, and
the first lead and the second lead are connected each other based on the first header and the second header being coupled.
